(19) United States
(12) Patent Application Publication
(10) Pub. No.: US 2015/0288103 A1
(43) Pub. Date: Oct. 8, 2015

(54) CONNECTOR

(71) Applicant: YAZAKI CORPORATION, Tokyo (JP)

(72) Inventors: Tetsuya SEKINO, Shizuoka (JP); Yoshifumi SHINMI, Shizuoka (JP)

(21) Appl. No.: 14/746,934

(22) Filed: Jun. 23, 2015

Related U.S. Application Data
(63) Continuation of application No. PCT/JP2013/082717, filed on Dec. 5, 2013.

(30) Foreign Application Priority Data
Dec. 25, 2012 (JP) 2012-280784
Apr. 1, 2013 (JP) 2013-075992

(51) Int. Cl. H01R 13/64; H01R 13/631

(52) U.S. Cl. CPC H01R 13/64; H01R 13/631

(57) ABSTRACT

A connector is provided with a first connector section which has a first housing section in which a first terminal is disposed, a second connector section which has a second housing section in which a second terminal is disposed, and a body section. The first housing section and the second housing section are fitted to each other, and the first terminal and the second terminal are connected. The first housing section is rotatably provided to the body section. The first housing section is provided with a guide rib. The second housing section is provided with a rotational position determination mechanism which, in order that the first housing section and the second housing section are at a regular rotating and fitting position, guides the guide rib to a position before the position at which the first terminal and the second terminal start to come into contact with each other.

### CROSS REFERENCE TO RELATED APPLICATIONS

This application is a Continuation of PCT Application No. PCT/JP2013/082717, filed on Dec. 5, 2013, and claims the priority of Japanese Patent Application No. 2012-280784, filed on Dec. 25, 2012, and Japanese Patent Application No. 2013-075992, filed on Apr. 1, 2013, the entire content of all of which are incorporated herein by reference.

### BACKGROUND

1. Technical Field

The present invention relates to a connector for fitting both housing portions to each other and electrically connecting terminals to each other.

2. Background Art

Various connectors of this kind are conventionally proposed (refer to JP 2000-182702 A). FIG. 25 illustrates a first conventional example of the connector. In FIG. 25, the connector 50 of the first conventional example is attached to a cylinder head 70 of an engine for extracting output of a fuel pressure sensor element (not shown) embedded in the cylinder head 70. The connector 50 is provided with a wire harness-side connector portion 51 and a sensor-side connector portion 60.

The wire harness-side connector portion 51 is provided with a first housing portion 52. A first terminal 53 is disposed in one end side of the first housing portion 52. An outer terminal 54 is disposed in the other end side of the first housing portion 52. The first terminal 53 and the outer terminal 54 are connected to each other through electric wires W accommodated in the first housing portion 52.

The sensor-side connector portion 60 is provided with a sensor body 61 in which a sensor element (not shown) is disposed, and a second housing portion 63 which is fixed to the sensor body 61 and is disposed in the second housing portion 63. A screw portion 61a is formed on an outer periphery of the sensor body 61. By threadedly inserting the sensor body 61 into a screw hole 70a of the cylinder head 70, the sensor-side connector portion 60 is attached to the cylinder head 70.

In the above-described configuration, the sensor-side connector portion 60 is attached to the cylinder head 70 and then, a head cover 71 is attached on the cylinder head 70. The wire harness-side connector portion 51 is inserted from a hole 71a of the head cover 71, and the wire harness-side connector portion 51 is assembled into the sensor-side connector portion 60.

### SUMMARY OF THE INVENTION

However, since the sensor-side connector portion 60 is fastened to the screw hole 70a of the cylinder head 70 through the screw, a rotating position (direction) of the second housing portion 63 is not constant. Further, when the wire harness-side connector portion 51 is assembled, the second housing portion 63 is located at the back of the hole 71a of the head cover 71. Therefore, the second housing portion 63 cannot clearly be recognized visually, it is difficult to place the first housing portion 52 at a precise regular rotating and fitting position with respect to the second housing portion 63, and there is a problem that fitting operability is poor.

The present invention has been accomplished to solve this problem, and it is an object of the invention to provide a connector capable of easily fitting the mating housing portion even if the mating housing portion is not clearly known visually.

According to a first aspect of the present invention, a connector comprises a cylindrical first connector portion including a first housing portion on which a first terminal is disposed, a cylindrical second connector portion being fittable with the first connector portion and including a second housing portion on which a second terminal is disposed connectable to the first terminal, and a cylindrical body portion which is rotatably provided on the first housing portion. The first housing portion and the second housing portion are fitted to each other, and in a fitting completion position where fitting operation between the first housing portion and the second housing portion is completed, the first terminal and the second terminal are connected to each other. One of the first housing portion and the second housing portion is provided with an induction rib portion. And the other one of the first housing portion and the second housing portion is provided with a rotating and positioning mechanism for guiding the induction rib portion such that the first housing portion and the second housing portion are located at a regular rotating and fitting position even if the induction rib portion is located at any of rotating positions up to a position before connection between the first terminal and the second terminal is started.

The rotating and positioning mechanism may be an inclined surface in which cylindrical one end surface of the other one of the first housing portion and the second housing portion is the highest at a position opposed to the regular rotating and fitting position and is the lowest at the regular rotating and fitting position.

The body portion may include an external connector portion on an opposite side of the first housing portion. In this case, the connector according to the first aspect may be provided with an electric wire for connecting the first terminal and an external terminal of the external connector portion, and a rotation-restricting portion for restricting excessive rotation of the first housing portion with respect to the body portion.

The first connector portion may be provided with an locked portion, the second connector portion may be provided with an locking portion, the body portion may be provided with an locked portion-holding portion. And when the first connector portion is installed to the second connector portion, the locked portion is locked with the locking portion, and the locked portion-holding portion holds a state where the locked portion is locked with the locking portion.

The connector according to the first aspect may further comprise a biasing member for giving a force to maintain a fitted state between the first connector portion and the second connector portion when the first connector portion is installed to the second connector portion.

According to the connector of the first aspect of the present invention, even if the first housing portion and the second housing portion start fitting to each other in a state where they are not located at the regular rotating and fitting position, they are located at the regular rotating and fitting position by the induction rib portion and the rotating and positioning mechanism until the first terminal and the second terminal start connecting to each other. Therefore, even if the mating housing portion is not clearly known visually, it is possible to easily fit the housing portions to each other.

### BRIEF DESCRIPTION OF THE DRAWINGS

FIG. 1 is a schematic sectional view of a state where a connector according to a first embodiment is attached to a cylinder head of an engine;

FIG. 2 is a perspective view before the connector according to the first embodiment is assembled;

FIG. 3 is an exploded perspective view of the connector according to the first embodiment;

FIG. 4A is an enlarged view of a portion C in FIG. 3;

FIG. 4B is a front view of an induction rib portion of the connector according to the first embodiment;

FIG. 5A is perspective view illustrating fitting process of the connector according to the first embodiment;

FIG. 5B is perspective view illustrating fitting process of the connector according to the first embodiment;

FIG. 5C is perspective view illustrating fitting process of the connector according to the first embodiment;

FIG. 5D is perspective view illustrating fitting process of the connector according to the first embodiment;

FIG. 6A is an exploded view of a connector according to a second embodiment;

FIG. 6B is a sectional view of a constituent part of a portion of the connector according to the second embodiment;

FIG. 7 is a figure illustrating a state where the connector according to the second embodiment is attached to a cylinder head of an engine, and illustrating that a second connector constituent body is attached to the cylinder head and a first connector constituent body and a third connector constituent body are separated from the second connector constituent body;

FIG. 8A is a figure illustrating a state where the connector according to the second embodiment is attached to the cylinder head, and illustrating that the second connector constituent body is attached to the cylinder head, and the first connector constituent body and the third connector constituent body are installed to the second connector constituent body;

FIG. 8B is a sectional view taken along line D-D in FIG. 8A;

FIG. 9 is an enlarged view of a portion E in FIG. 8B;

FIG. 10 is a figure illustrating a halfway state when the first connector constituent body and the third connector constituent body are installed to the second connector constituent body of the connector according to the second embodiment;

FIG. 11 is a figure illustrating a halfway state when the first connector constituent body and the third connector constituent body are installed to the second connector constituent body of the connector according to the second embodiment;

FIG. 12 is a figure illustrating a halfway state when the first connector constituent body and the third connector constituent body are installed to the second connector constituent body of the connector according to the second embodiment;

FIG. 13 is a figure illustrating a halfway state when the first connector constituent body and the third connector constituent body are installed to the second connector constituent body of the connector according to the second embodiment;

FIG. 14 is a figure illustrating a state where the first connector constituent body and the third connector constituent body have been installed to the second connector constituent body of the connector according to the second embodiment;

FIG. 15 is an exploded view of a connector according to a third embodiment.

FIG. 16 is a perspective view of the connector according to the third embodiment;

FIG. 17A is perspective view illustrating a state where the connector according to the third embodiment is attached to a cylinder head of an engine, wherein a second connector constituent body is attached to the cylinder head, a first connector constituent body, a third connector constituent body and a fourth connector constituent body are separated from the second connector constituent body;

FIG. 17B is perspective view illustrating a state where the connector according to the third embodiment is attached to a cylinder head of an engine, wherein the second connector constituent body is attached to the cylinder head, and the first connector constituent body, the third connector constituent body and the fourth connector constituent body are installed to the second connector constituent body;

FIG. 18 is a figure illustrating a halfway state when the first connector constituent body, the third connector constituent body and the fourth connector constituent body are installed to the second connector constituent body of the connector according to the third embodiment;

FIG. 19 is a figure illustrating a halfway state when the first connector constituent body, the third connector constituent body and the fourth connector constituent body are installed to the second connector constituent body of the connector according to the third embodiment;

FIG. 20 is a figure illustrating a halfway state when the first connector constituent body, the third connector constituent body and the fourth connector constituent body are installed to the second connector constituent body of the connector according to the third embodiment;

FIG. 21 is a figure illustrating a halfway state when the first connector constituent body, the third connector constituent body and the fourth connector constituent body are installed to the second connector constituent body of the connector according to the third embodiment;

FIG. 22 is a figure illustrating a halfway state when the first connector constituent body, the third connector constituent body and the fourth connector constituent body are installed to the second connector constituent body of the connector according to the third embodiment;

FIG. 23 is a figure illustrating a state when the first connector constituent body, the third connector constituent body and the fourth connector constituent body have been installed to the second connector constituent body of the connector according to the third embodiment;

FIG. 24 is a figure illustrating a connector according to a second conventional example; and

FIG. 25 is a schematic perspective view of a connector according to a first conventional example.

### DESCRIPTION OF THE EMBODIMENTS

Embodiments of the present invention will be described below with reference to the drawings.

### First Embodiment

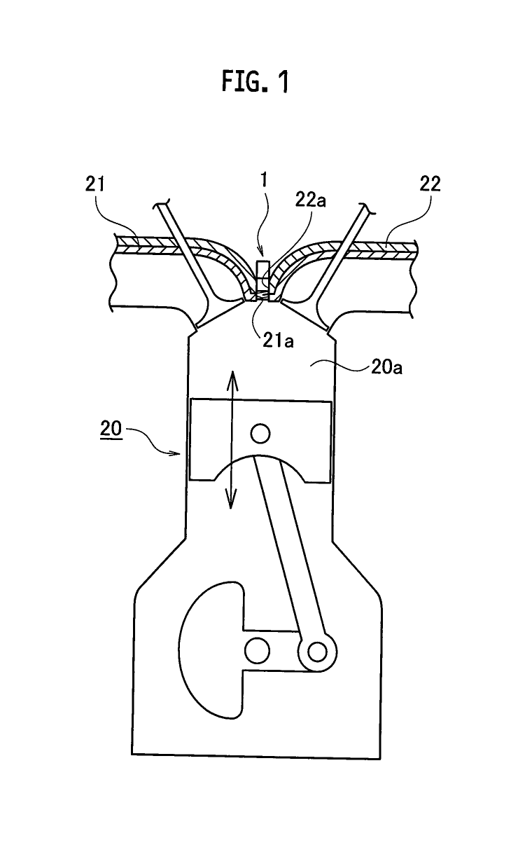

FIGS. 1 to 5D illustrate a first embodiment. A connector 1 according to the first embodiment is integrally provided with a fuel pressure sensor element (not shown), and is attached to a cylinder head 21 of an engine 20.

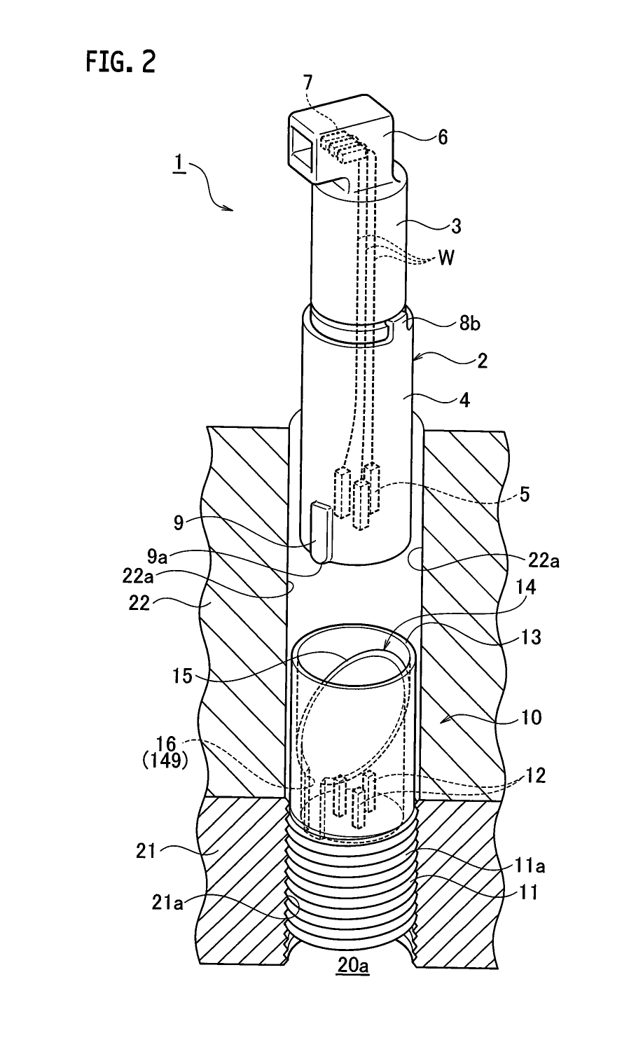

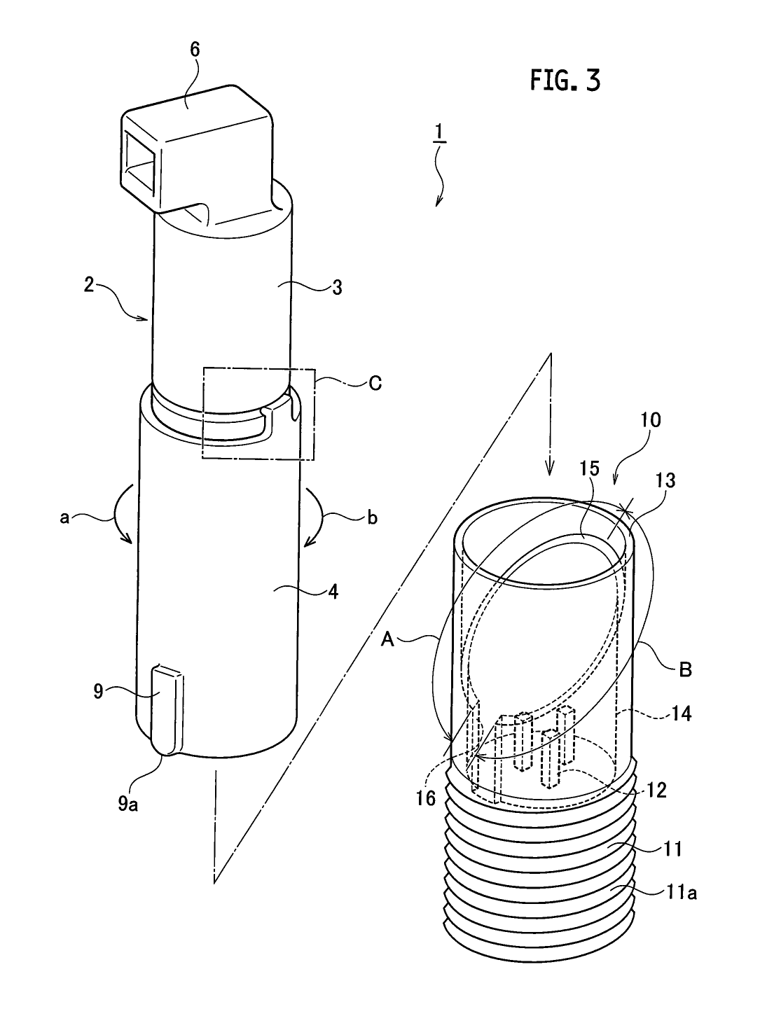

As illustrated in FIGS. 2 and 3, the connector 1 according to the first embodiment includes a first connector portion 2 which is a wire harness-side connector portion, a second connector portion 10 which is a sensor-side connector portion attached to the first connector portion 2, and a cylindrical body portion 3.

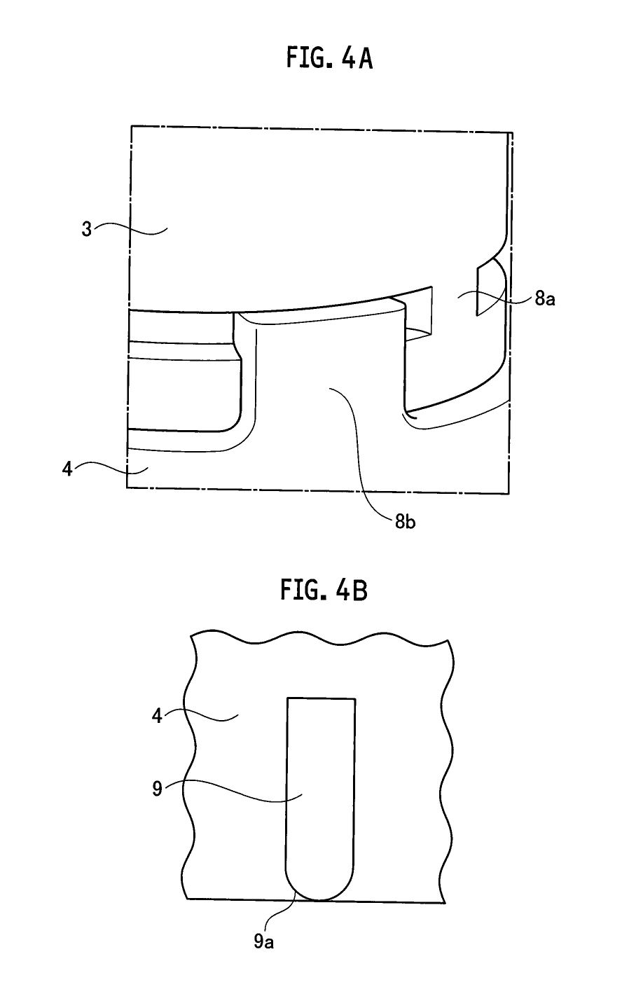

The first connector portion 2 includes a cylindrical first housing portion 4 which is rotatably provided on one end side of the body portion 3. First terminals 5 which are female terminals are disposed in a fitting chamber of one end side of the first housing portion 4. An outer connector portion 6 is provided on the other end side of the body portion 3. A direction which is substantially perpendicular to a housing-fitting direction of one end side of the first housing portion 4 is a housing-fitting direction of the outer connector portion 6. Outer terminals 7 is disposed in a fitting chamber of the outer connector portion 6. A connector (not shown) of a vehicle-side wire harness is connected to the outer connector portion 6. The first terminals 5 and the outer terminals 7 are connected to each other through electric wires W accommodated in the body portion 3. The electric wires W are accommodated in a state having extra lengths. As illustrated in FIG. 4A, the first housing portion 4 and the body portion 3 are provided with rotation-restricting portions 8a and 8b for restricting the first housing portion 4 and the body portion 3 from excessively rotating. Accordingly, the electric wires W in the body portion 3 are prevented from being excessively twisted. An induction rib portion 9 projects from an outer periphery of the other end side of the first housing portion 4. As illustrated in FIG. 4B, an entire region of a lower end surface of the induction rib portion 9 is formed into an arc surface 9a. A central portion of the arc surface 9a is the lowest, and left and right sides of the arc surface 9a gradually rise upward.

The second connector portion 10 includes a sensor body portion 11 in which a fuel pressure sensor element (not shown) is disposed, an outer guide cylinder portion 13 fixed to the sensor body portion 11, and a second housing portion 14 fixed to the sensor body portion 11 and disposed in the outer guide cylinder portion 13. A screw portion 11a is formed on an outer periphery of the sensor body portion 11. By threadedly inserting the sensor body portion 11 into a screw hole 21a of the cylinder head 21, the second connector portion 10 is attached to the cylinder head 21 (see FIG. 2). Since the second connector portion 10 is fastened through the screw in this manner, the second housing portion 14 of the second connector portion 10 is attached not in a specific direction (rotating position) but in an arbitrary direction (rotating position).

The outer guide cylinder portion 13 has a cylindrical shape, and an upper surface of the outer guide cylinder portion 13 opens.

The second housing portion 14 has a cylindrical shape as will be described in detail below, and an upper surface of the second housing portion 14 opens. Second terminals 12 which are male terminals are disposed in a fitting chamber of the second housing portion 14, and the upper surface of the second terminals 12 opens. The second terminals 12 are for extracting output from the fuel pressure sensor element.

The second housing portion 14 has a cylindrical shape, and an upper end surface of the second housing portion 14 is diagonally cut. This diagonal upper end surface is formed as an induction rail surface 15 as a rotating and positioning mechanism. That is, the induction rail surface 15 is such an inclined surface that an upper end surface of the cylindrical second housing portion 14 is the highest at a position opposed to a regular rotating and fitting position, and is the lowest at the regular rotating and fitting position. If the induction rib portion 9 abuts against the induction rail surface 15, the induction rail surface 15 guides the induction rib portion 9 such that the first housing portion 4 and the second housing portion 14 come to the regular rotating and fitting position up to a fitting position before the first terminals 5 and the second terminals 12 start contacting with each other.

A straight guide groove 16 is formed in the second housing portion 14. The guide groove 16 opens at the lowest position of the induction rail surface 15. The guide groove 16 restricts rotation of the induction rib portion 9, and permits only fitting movement of the first housing portion 4 into the second housing portion 14 at the regular rotating and fitting position. After the induction rib portion 9 enters the guide groove 16, the first terminals 5 and the second terminals 12 start contacting with each other, and the first terminals 5 and the second terminals 12 are brought into an appropriate contact state at a fitting completion position where the induction rib portion 9 enters the guide groove 16 all the way in.

In the above-described configuration, the first connector portion 2 is attached to the cylinder head 21 and then, a head cover 22 is attached to the cylinder head 21. A hole 22a is formed in the head cover 22 at an attaching position of the second connector portion 10, and the first connector portion 2 is assembled from the hole 22a.

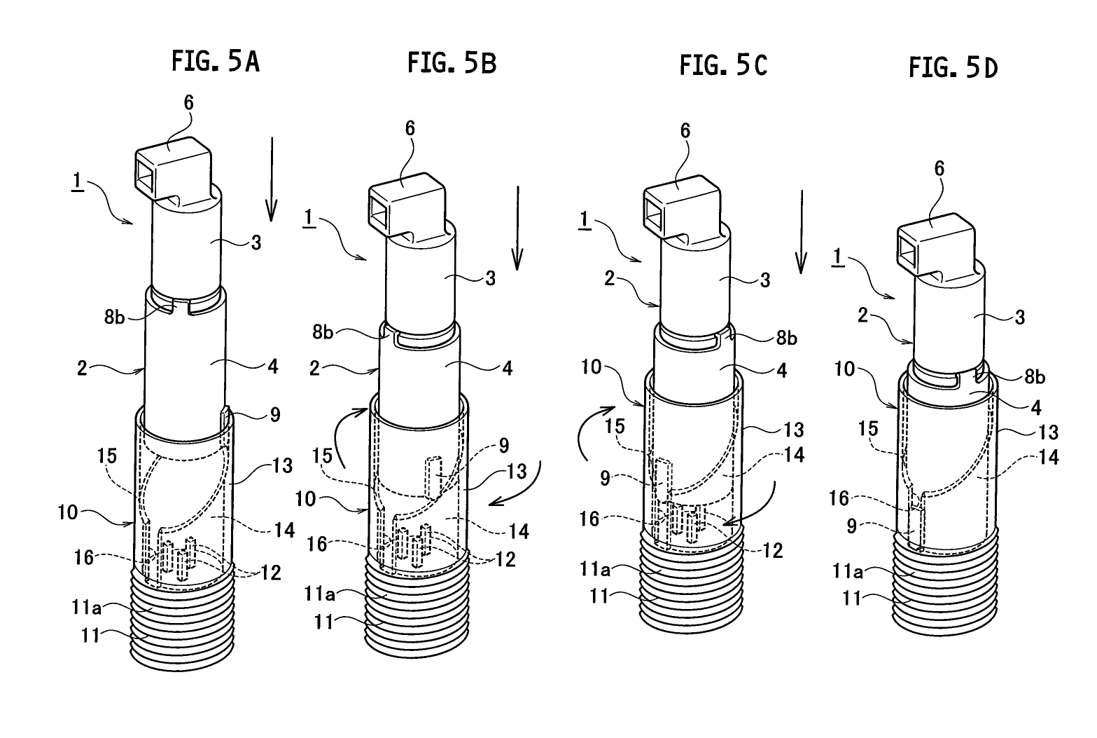

Next, assembling operation of the first connector portion 2 will be described. A direction (rotating position) of the outer connector portion 6 is set to a desired direction, and the first connector portion 2 is inserted into the outer guide cylinder portion 13 through the hole 22a of the head cover 22. Then, as illustrated in FIG. 5A, the induction rib portion 9 of the first housing portion 4 abuts against an arbitrary portion of the induction rail surface 15 of the second housing portion 14 except when the first housing portion 4 is inserted into the second housing portion 14 at the regular rotating and fitting position. Then, as illustrated in FIG. 5B, if the induction rib portion 9 abuts against a region A illustrated in FIG. 3, the first housing portion 4 rotates in a direction of arrow “a” in FIG. 3 and in this state, the first housing portion 4 moves into a fitting direction. If the induction rib portion 9 abuts against a region B in FIG. 3, the first housing portion 4 rotates in a direction of an arrow “b” in FIG. 3 and in this state, the first housing portion 4 moves into the fitting direction. In this manner, the first housing portion 4 comes to a rotating position where the induction rib portion 9 is located at the lowest position of the induction rail surface 15 as illustrated in FIG. 5C. According to this, the first housing portion 4 and the second housing portion 14 are located at the regular rotating and fitting position. Thereafter, if the fitting motion of the first housing portion 4 further moves ahead, the induction rib portion 9 enters the straight guide groove 16, and the first housing portion 4 is inserted into the fitting completion position as illustrated in FIG. 5D. When the induction rib portion 9 enters the straight guide groove 16, the first terminal 5 and the second terminal 12 start connecting with each other, and they are located at appropriate connected position in the fitting completion position. According to this, the assembling operation of the first connector portion 2 is completed.

When the first housing portion 4 starts fitting into the second housing portion 14 at the regular rotating and fitting position, the induction rib portion 9 enters the straight guide groove 16 without sliding on the induction rail surface 15, and the induction rib portion 9 is inserted into the fitting completion position as illustrated in FIG. 5D.

The first housing portion 4 is rotatably provided with the body portion 3, the connector 1 is provided with the induction rib portion 9, and the second housing portion 14 is provided with the induction rail surface 15 as the rotating and positioning mechanism which guides the induction rib portion 9 to the regular rotating position up to a position before the first terminal and the second terminal start contacting with each other even if the induction rib portion 9 is located at any of the rotating positions. Therefore, even if the first housing portion 4 and the second housing portion 14 start fitting to each other not at the regular rotating and fitting position, they are located at the regular rotating and fitting position by the induction rib portion 9 and the induction rail surface 15 up to a position where the first terminal 5 and the second terminal 12 start connecting with each other. Therefore, even if the rotating position of the second connector portion 10 and the second housing portion 14 is not known, it is possible to easily carry out the fitting operation between the first housing portion 4 and the second housing portion 14.

The rotating and positioning mechanism is the induction rail surface 15 having such an inclined surface that the upper end surface of the second housing portion 14 is the highest at the position opposed to the regular rotating and fitting position and is the lowest at the regular rotating and fitting position. Therefore, the maximum rotation angle of the first housing portion 4 is 180°, the maximum twisting amount of the electric wires W in the first connector portion 2 is half of a circumference of the first housing portion 4 at the maximum. Hence, extra length of the electric wire W can be shortened as compared with a configuration in which the first housing portion 4 rotates 360°.

The body portion 3 includes the outer connector portion 6 provided on the side opposite from the first housing portion 4. Therefore, the first connector portion 2 can be attached to the second connector portion 10 while setting the direction of the outer connector portion 6 to a desired direction irrespective of a direction (rotating position) of the second connector portion 10. According to this, the outer connector portion 6 and the connector portion (not shown) of the wire harness can be connected to each other in a desired direction. The outer terminal 7 of outer connector portion 6 and the first terminal 5 are connected to each other through the electric wires W having extra lengths. According to this, the first housing portion 4 can rotate toward the body portion 3 while maintaining the connection between the outer terminal 7 and the first terminal 5.

The first terminal 5 and the outer terminal 7 of the outer connector portion 6 are connected to each other through the electric wires W, and the rotation-restricting portions 8a and 8b which restrict excessive rotation of the first housing portion 4 are provided. Therefore, it is possible to prevent the electric wires W from being damaged (e.g., disconnection) by the excessive rotation.

### (Others)

Although the first connector portion 2 is rotatably provided on the body portion 3 in the first embodiment, the second connector portion 10 may rotatably be provided on the sensor body portion 11. The first connector portion 2 may rotatably be provided on the body portion 3, and the second connector portion 10 may rotatably be provided on the sensor body portion 11. That is, both the first connector portion 2 and the second connector portion 10 may rotatably be provided.

The induction rib portion 9 is provided on the first housing portion 4 of the first connector portion 2, and the induction rail surface 15 is provided on the second housing portion 14 of the second connector portion 10 in the first embodiment. Reversely, the induction rail surface 15 may be provided on the first housing portion 4 of the first connector portion 2, and the induction rib portion 9 may be provided on the second housing portion 14 of the second connector portion 10.

The connector 1 is integrally provided with the fuel pressure sensor element (not shown) and the connector 1 is attached to the cylinder head 21 of the engine 20 in the first embodiment, but the present invention is not limited to this. The connector 1 of the first embodiment may be applied irrespective of the presence or absence of the sensor element and may be applied to such a configuration that the connector 1 is integrally provided with a part other than the sensor element. The connector 1 of the first embodiment is effective when the mating housing portion is visually unknown, but the connector 1 can be utilized even when the mating housing portion can visually be seen. According to the connector 1 of the first embodiment, it is possible to easily carry out the fitting operation without giving consideration to a direction (rotating position) of the mating housing.

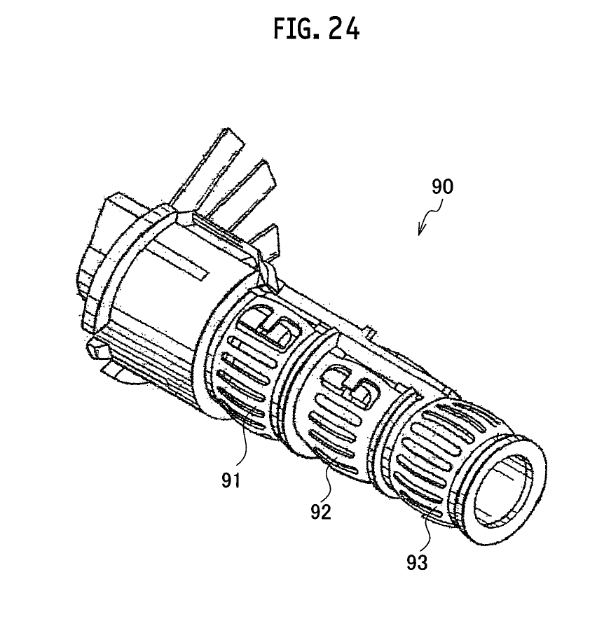

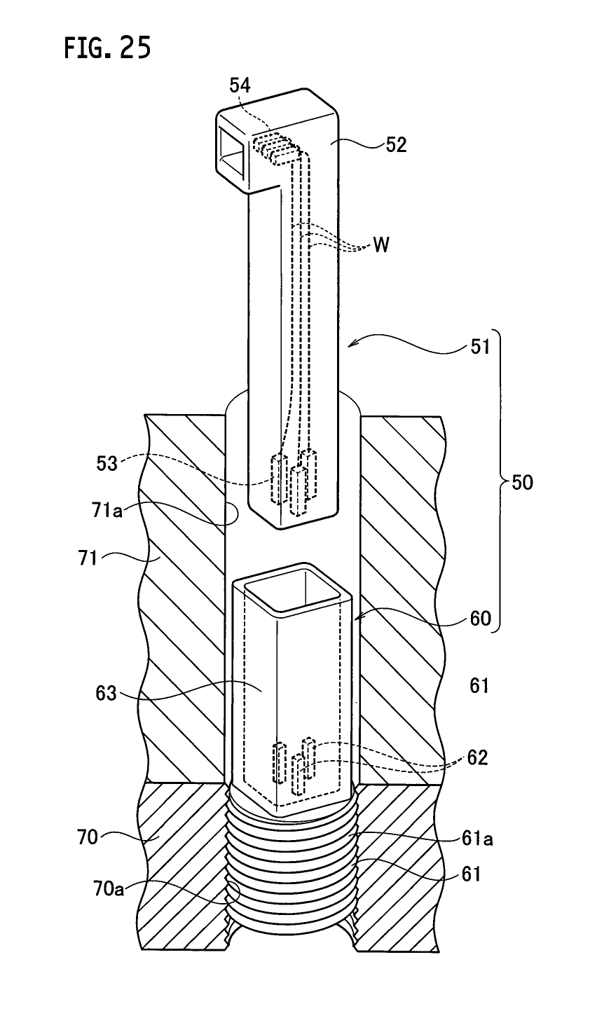

According to the connector 1 of the first embodiment, its configuration can be simplified as compared with a connector 90 (see FIG. 24) of the second conventional example described in Patent Literature US 2010/0003841 A1.

That is, according to the connector 90 of the second conventional example, contact parts 91, 92 and 93 are formed into a multi-contact structure for measurement against vibration, its configuration is complicated, it is difficult to guarantee fitting phenomenon, and the connector 90 is expensive. In the connector 1 of the first embodiment, on the other hand, the multi-contact structure is not employed, the configuration is simple, and it is possible to reduce costs.

### Second Embodiment

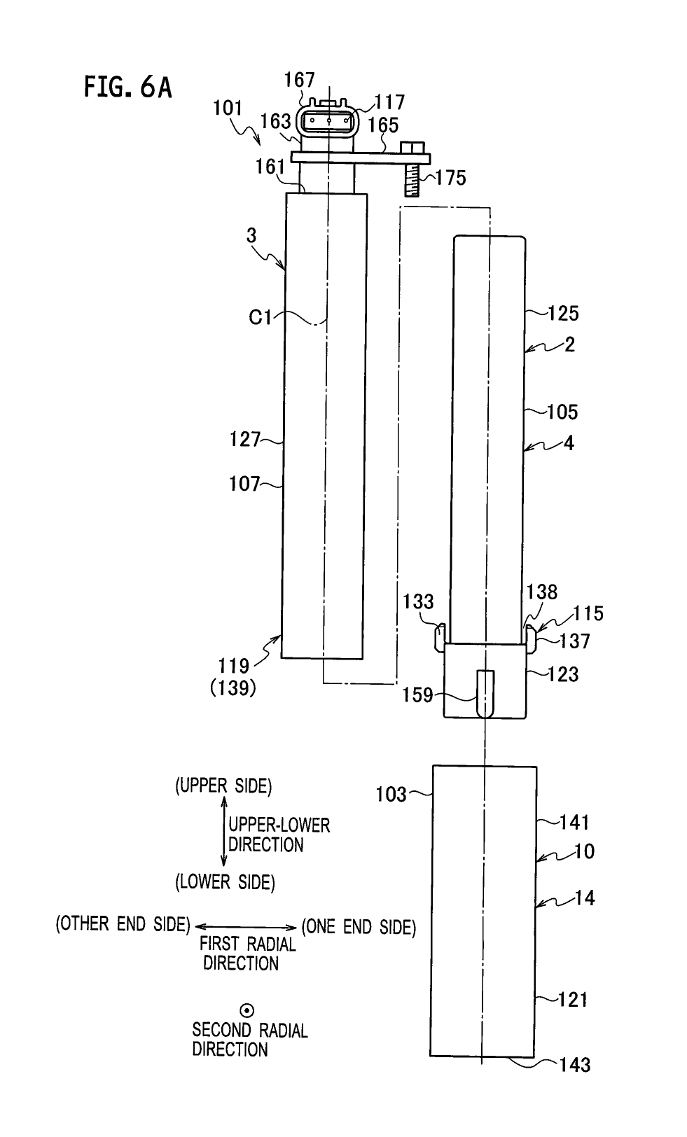

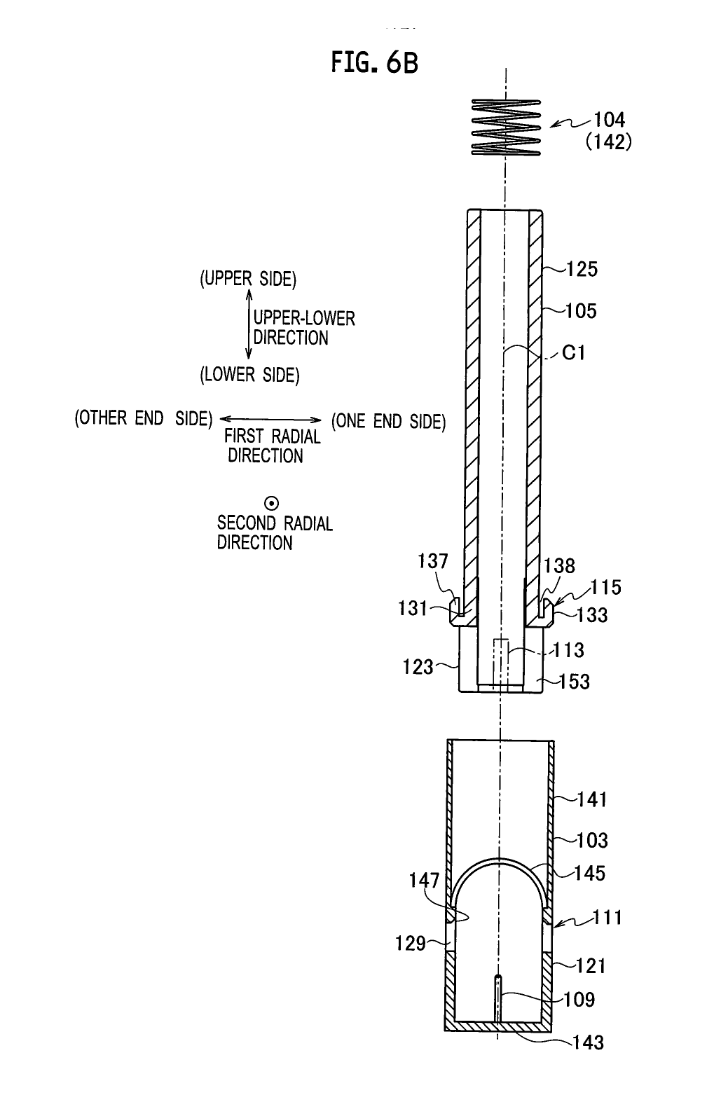

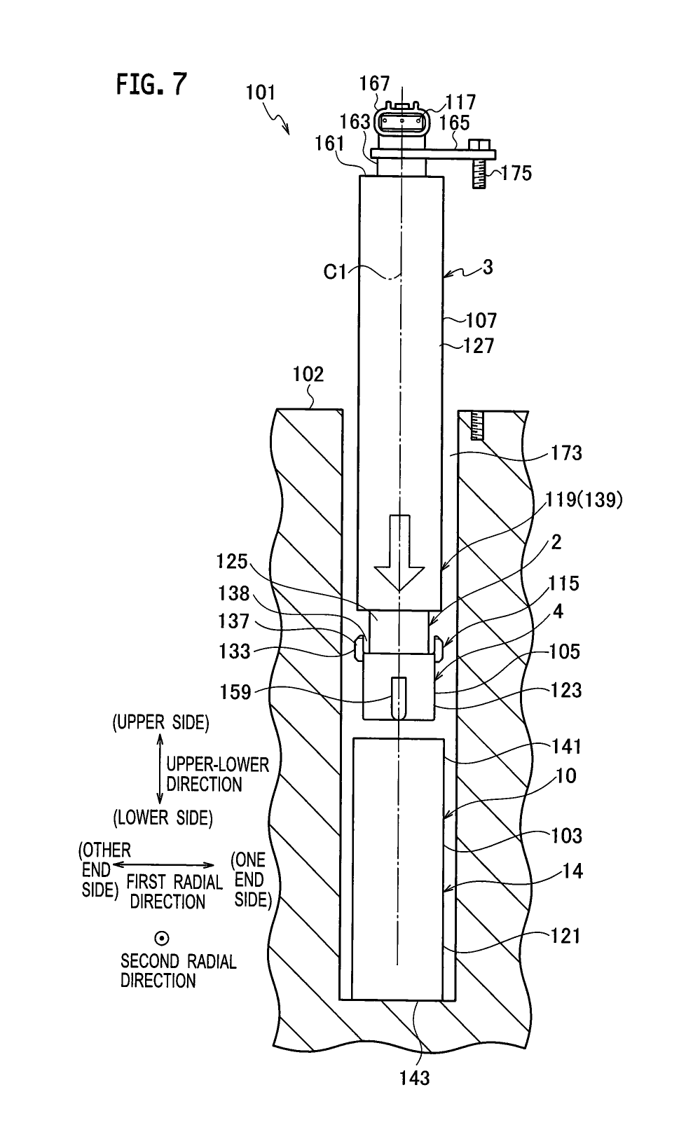

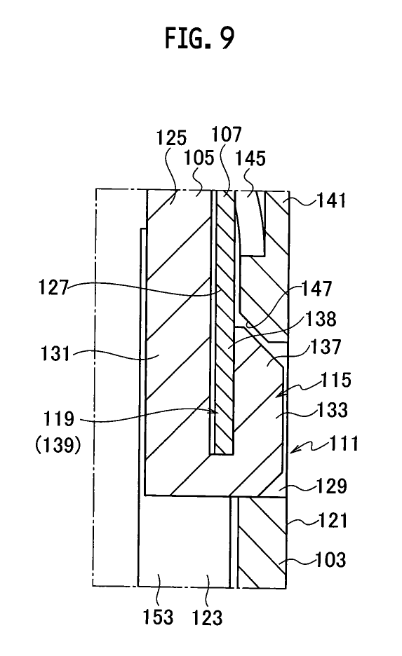

FIGS. 6A to 14 illustrate a second embodiment. A connector 101 of the second embodiment is different from the connector 1 of the first embodiment mainly in that when a first connector portion is installed to a second connector portion, a installation state of the connectors is held using an locked portion, an locking portion and an locked portion-holding portion. Other configurations of the second embodiment are substantially the same as those of the connector 1 of the first embodiment, the connector 101 can similarly be deformed and exerts substantially the same effects.

As illustrated in FIGS. 6A to 10 and 14, the connector 101 is provided with a first connector portion 2, a second connector portion 10 and a body portion 3.

The first connector portion 2 is provided with an locked portion 115. The second connector portion 10 is provided with an locking portion 111. The body portion 3 is provided with an locked portion-holding portion 119.

When the first connector portion 2 is installed to the second connector portion 10, the locked portion 115 is locked with the locking portion 111, and the locked portion-holding portion 119 holds the state where the locked portion 115 is locked with the locking portion 111.

The connector 101 is provided with a biasing member 104 which gives a force to maintain the fitted state between the first connector portion 2 and the second connector portion 10 when the first connector portion 2 is installed to the second connector portion 10.

The first connector portion 2 is provided with a first connector constituent body 105 as a first housing portion 4. The second connector portion 10 is provided with a second connector constituent body 103 as a second housing portion 14. The body portion 3 is provided with a third connector constituent body 107.

The first connector constituent body 105 is provided with a first cylindrical portion 123 provided with first terminals 113 in the first cylindrical portion 123. The second connector constituent body 103 is provided with a first cylindrical portion 121 provided with second terminals 109 in the first cylindrical portion 121.

An inner diameter of the first cylindrical portion 121 of the second connector constituent body 103 is slightly larger than an outer diameter of the first cylindrical portion 123 of the first connector constituent body 105. In a state where the first connector constituent body 105 is installed to the second connector constituent body 103, the first cylindrical portion 123 of the first connector constituent body 105 enters the first cylindrical portion 121 of the second connector constituent body 103, and the first cylindrical portion 123 of the first connector constituent body 105 and the first cylindrical portion 121 of the second connector constituent body 103 are brought into a fitted state.

The first connector constituent body 105 is provided with a second cylindrical portion 125 having an outer diameter smaller than an inner diameter of the first cylindrical portion 121 of the second connector constituent body 103. An outer diameter of the third connector constituent body 107 is provided with a cylindrical portion 127. An outer diameter of the cylindrical portion 127 is slightly smaller than an inner diameter of the first cylindrical portion 121 of the second connector constituent body 103, and an inner diameter of the cylindrical portion 127 is slightly larger than an outer diameter of the second cylindrical portion 125 of the first connector constituent body 105.

The locking portion 111 is composed of through holes 129 provided in the first cylindrical portion 121 of the second connector constituent body 103. The locking portion 111 may be composed of the through holes 129, or may be composed of a recess. That is, the locking portion 111 may be composed of at least one of the through holes 129 and the recess provided in the first cylindrical portion 121 of the second connector constituent body 103.

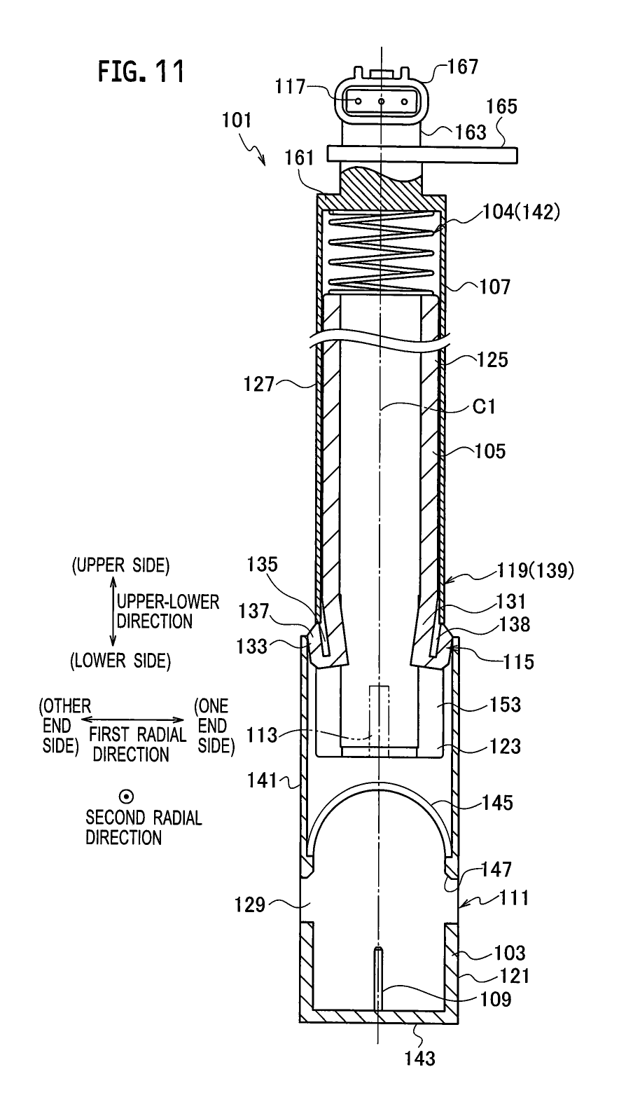

The locked portion 115 includes a elastic arm 131 and an locked pawl 133. The elastic arm 131 is formed into a cantilever beam shape by providing notches 135 (see FIG. 11) in the second cylindrical portion 125 of the first connector constituent body 105. The locked pawl 133 projects and is folded back outward of the second cylindrical portion 125 of the first connector constituent body 105 from a tip end of the elastic arm 131. A folded back portion 137 formed by this folded back configuration is separated from the elastic arm 131 by a predetermined distance. A portion (tip end) 139 of the cylindrical portion 127 of the third connector constituent body 107 configures the locked portion-holding portion 119.

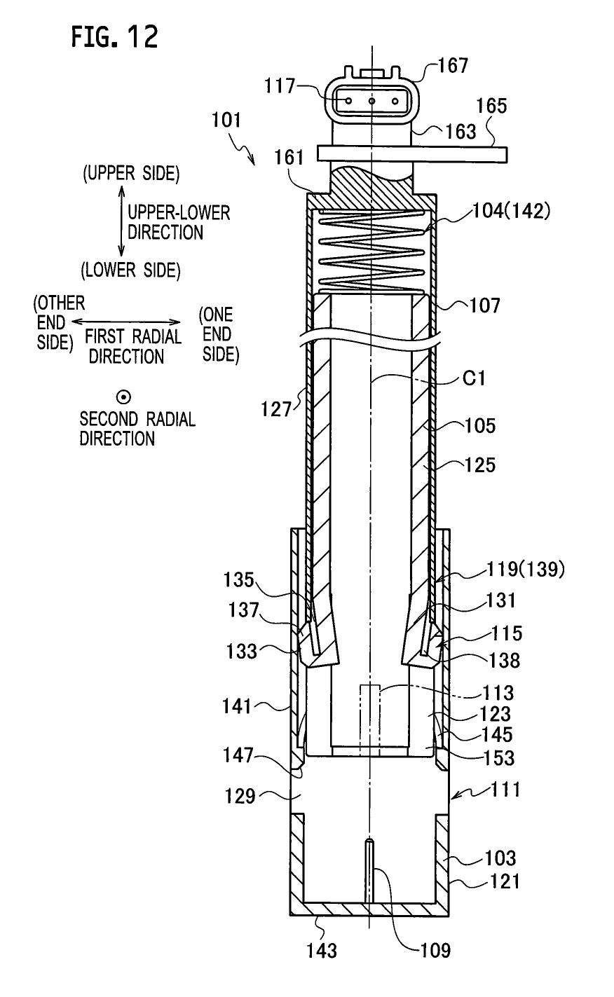

In a halfway state where the first connector constituent body 105 is installed to the second connector constituent body 103, the elastic arm 131 is pushed by a second cylindrical portion 141 of the second connector constituent body 103 and the first cylindrical portion 121, and is elastically deformed inward as illustrated in FIGS. 11 and 12. Details of the second cylindrical portion 141 of the second connector constituent body 103 will be described later.

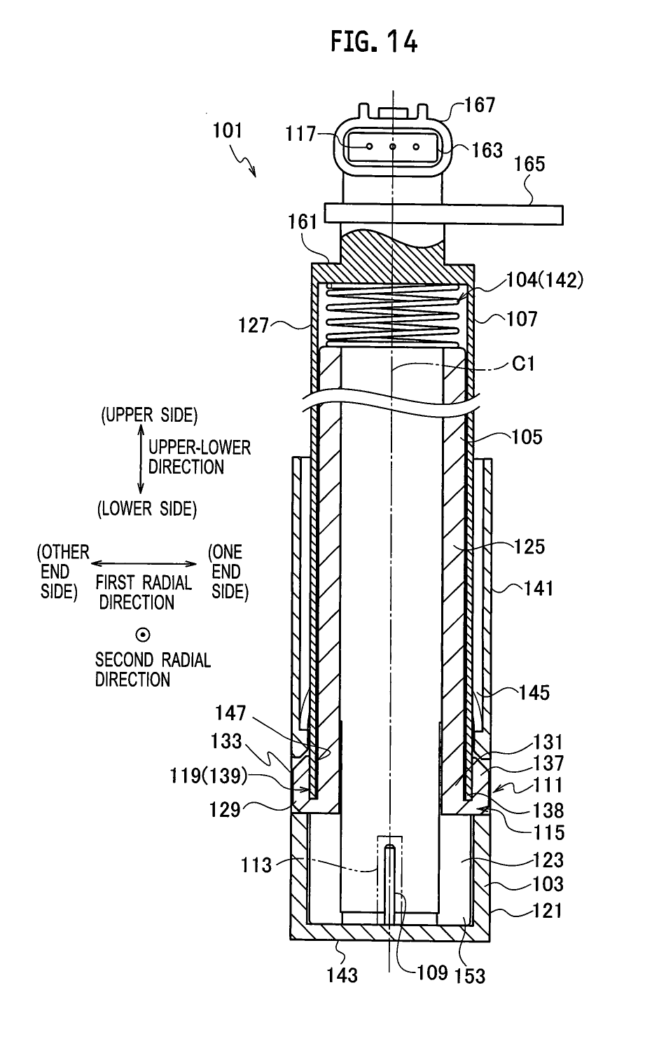

In a state where the first connector constituent body 105 has been installed to the second connector constituent body 103, as illustrated in FIG. 14, the elastic arm 131 restores, the folded back portion 137 formed by the folding back configuration of the locked pawl 133 of the elastic arm 131 enters the through hole 129 configuring the locking portion 111, and the locked portion 115 is locked with the locking portion 111.

In a state where the third connector constituent body 107 has been installed to the first connector constituent body 105 installed to the second connector constituent body 103, the cylindrical portion 127 of the third connector constituent body 107 enters the first cylindrical portion 121 of the second connector constituent body 103, the second cylindrical portion 125 of the first connector constituent body 105 enters the cylindrical portion 127 of the third connector constituent body 107, and the locked portion-holding portion 119 enters a space 138 between the elastic arm 131 and the folded back portion 137 formed by the folding back configuration of the locked pawl 133. According to this, a state where the locked portion 115 is locked with the locking portion 111 is maintained.

The biasing member 104 is composed of a elastic body (e.g., compression coil spring) 142 provided between the first connector constituent body 105 and the third connector constituent body 107. The elastic body 142 biases the first connector constituent body 105 toward the second connector constituent body 103 in a state where the third connector constituent body 107 has been installed to the first connector constituent body 105 which is installed to the second connector constituent body 103.

The second connector constituent body 103 is a standby male connector for example, and includes the second terminals 109 and the locking portion 111. The second connector constituent body 103 is first integrally attached to the cylinder head 102 of the engine.

The second connector constituent body 103 is provided with an ignition device (not shown) such as a glow plug of a diesel engine. The second terminals 109 are male terminals, and there are the plurality of second terminals 109. The second terminals 109 are electrically connected to the glow plug.

Instead of providing the ignition device on the second connector constituent body 103, or in addition to the ignition device, a sensor element such as a combustion pressure sensor element may be provided. Even if the sensor element is provided, the sensor element is electrically connected to the second terminals 109.

The first connector constituent body 105 includes the first terminals 113 and the locked portion 115. The first terminals 113 of the first connector constituent body 105 are bonded (connected) to the second terminals 109 when the first connector constituent body 105 is installed to the second connector constituent body 103.

The first connector constituent body 105 is a female connector (e.g., glow plug-side female connector). The first terminals 113 are composed of female terminals, and a plurality of female terminals are provided.

By installing the first connector constituent body 105 on the second connector constituent body 103, the second terminals 109 of the second connector constituent body 103 and the first terminals 113 of the first connector constituent body 105 are respectively bonded to each other.

The third connector constituent body 107 is provided with a third terminal 117 and the locked portion-holding portion 119. When the third connector constituent body 107 is installed to the first connector constituent body (installed first connector constituent body) 105 which is installed to the second connector constituent body 103, the locked portion-holding portion 119 enters the space 138 of the elastic arm 131 to prevent the elastic arm 131 from deforming, and the locked portion-holding portion 119 maintains a state where the locked portion 115 is locked with the locking portion 111 (see FIG. 14 and the like).

The third connector constituent body 107 is a wire harness-side male connector for example. The third terminal 117 is composed of a male terminal, and a plurality of third terminals 117 are provided.

The first terminals 113 and the third terminals 117 are flexible, and they are electrically connected to each other through wires (not shown in FIGS. 6A to 14) (electric wires W extending inside of the first connector constituent body 105 and the third connector constituent body 107; see FIG. 2). Therefore, the first connector constituent body 105 and the third connector constituent body 107 are connected to each other through a flexible wire. A position and an attitude of the third connector constituent body 107 can be changed with a freedom degree of a certain level (within range permitted by flexible wire) with respect to the first connector constituent body 105.

A wire harness (not shown) is connected to the third terminal 117. If the third connector constituent body 107 is installed to the installed first connector constituent body 105 and the wire harness is connected to the third terminal 117, the second terminal 109 is electrically connected to the wire harness through the first terminal 113, the flexible wire and the third terminal 117.

In a state where the locked portion 115 is locked with the locking portion 111, this state is maintained (kept) unless the third connector constituent body (installed third connector constituent body) 107 which is installed to the installed first connector constituent body 105 is separated from the first connector constituent body 105. That is, if the locked portion-holding portion 119 is engaged with the locked portion 115, a state where the locked portion 115 is locked with the locking portion 111 is maintained. To release the maintained state held by the locked portion-holding portion 119 (by moving third connector constituent body 107 upward in FIG. 14) to upwardly move the installed first connector constituent body 105 from the state illustrated in FIG. 14 and to detach the first connector constituent body 105 from the second connector constituent body 103, it is first necessary to separate the locked portion-holding portion 119 from the locked portion 115.

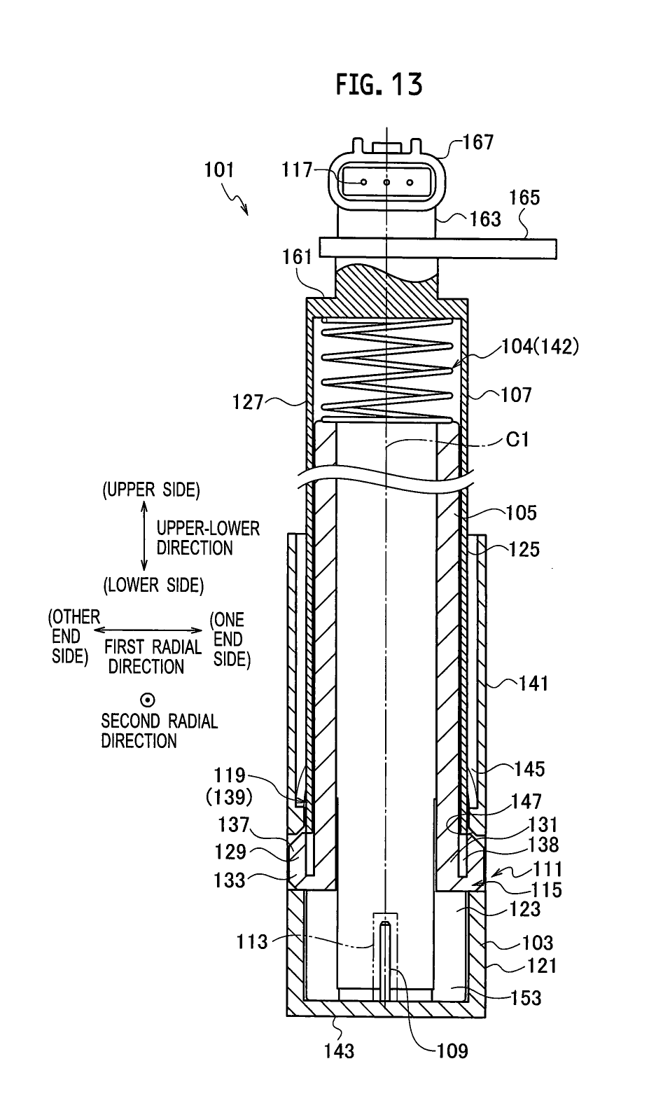

In the connector 101, as illustrated in FIG. 13, even in a state where the first connector constituent body 105 is installed to the second connector constituent body 103 (even if first connector constituent body 105 has been installed), the locked portion 115 is locked with the locking portion 111. If the third connector constituent body 107 is installed to the installed first connector constituent body 105 as illustrated in FIG. 14, the locked portion-holding portion 119 is engaged with the locked portion 115, the locked portion 115 is not deformed from the state where it is engaged with the locking portion 111, and the state where the locked portion 115 is engaged with the locking portion 111 is maintained (kept).

The elastic arm 131 is formed into the cantilever beam shape by providing at least the pair of notches 135 in the second cylindrical portion 125 of the first connector constituent body 105. The pair of notches 135 extends long in an extending direction of a center axis C1 of the second cylindrical portion 125 of the first connector constituent body 105. The notches 135 penetrate a thick portion of the second cylindrical portion 125 of the first connector constituent body 105 at a slight distance from each other in a circumferential direction of the second cylindrical portion 125 of the first connector constituent body 105. By providing the pair of notches 135, the one elastic arm 131 is formed.

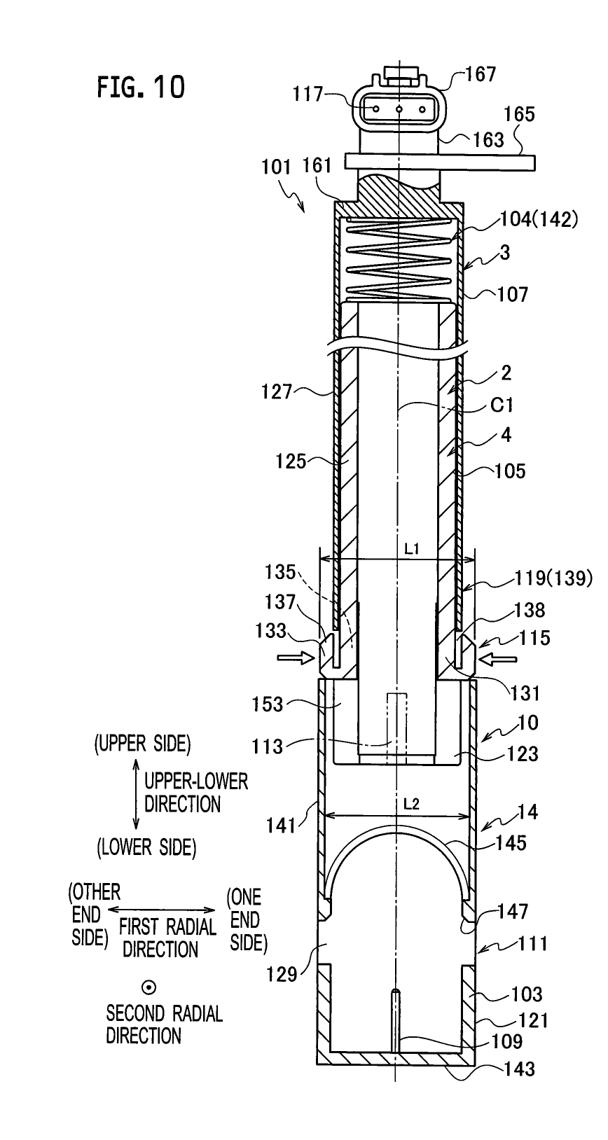

In a state where an external force is not applied to the elastic arm 131 (normal state; non-engaged state), the elastic arm 131 extends straightly in the extending direction of the center axis C1 as illustrated in FIG. 10 and the like.

As illustrated in FIG. 10 and the like, the locked pawl 133 is formed such that it projects outward of the second cylindrical portion 125 of the first connector constituent body 105 from a tip end of the elastic arm 131 and is folded back. The folded back portion 137 formed by this folded back configuration is separated from the elastic arm 131 by the predetermined distance (gap equal to or slightly larger than thickness value of thick portion of cylindrical portion 127 of third connector constituent body 107) 138.

Since the elastic arm 131 extends straightly in the state where no external force is applied thereto, a distance value between the outermost end of the locked pawl 133 and the center axis C1 of the second cylindrical portion 125 of the first connector constituent body 105 is slightly larger than a ½ value of an inner diameter of the second cylindrical portion 141 of the second connector constituent body 103.

As illustrated in FIG. 10 for example, if two locked portions 115 (elastic arm 131 and locked pawl 133) are provided symmetrically with respect to the center axis C1 of the second cylindrical portion 125 of the first connector constituent body 105, a distance L1 between outermost ends of the pair of locked pawls 133 is slightly larger than an inner diameter L2 of the first cylindrical portion 121 of the second connector constituent body 103 in the state where no external force is applied.

In a state where the third connector constituent body 107 is installed to the first connector constituent body 105 which is installed to the second connector constituent body 103 (state where third connector constituent body 107 has been installed), center axes C1 of all of the cylindrical portions 121, 123, 125, 127 and 141 match with each other as illustrated in FIG. 14 and the like. The cylindrical portion 127 (lower end 139) of the third connector constituent body 107 enters the first cylindrical portion 121 of the second connector constituent body 103, the second cylindrical portion 125 of the first connector constituent body 105 enters the cylindrical portion 127 of the third connector constituent body 107, and the locked portion-holding portion 119 enters the space (gap) 138 formed between the elastic arm 131 and the folded back portion 137 which is formed by folding back the locked pawl 133.

According to this, a state where the locked portion 115 is locked with the locking portion 111 is maintained.

The connector 101 will be described in more detail. For the purpose of illustration, an extending direction of the center axes C1 of the cylindrical portions 121, 123, 125, 127 and 141 is defined as a upper-lower direction, predetermined one direction which intersects with the upper-lower direction at right angles is defined as a first radial direction, and predetermined another direction which intersects with the upper-lower direction and the first radial direction at right angles is defined as a second radial direction.

The second connector constituent body 103 of the connector 101 is integrally attached to the cylinder head 102 by a male screw (not shown) in the same manner as the connector 1 of the first embodiment. Therefore, in a state where the second connector constituent body 103 is attached to the cylinder head 102, a rotation angle of the second connector constituent body 103 around the center axis C1 does not stay constant and varies due to individual differences of the second connector constituent body 103 and the cylinder head 102. For example, if second connector constituent bodies 103 of two connectors 101 are attached to two cylinder heads 102, respectively, a rotation angle of the first second connector constituent body 103 around the center axis C1 and a rotation angle of the second connector constituent body 103 around the center axis C1 may match with each other but are different from each other in many cases.

On the other hand, in order to obtain a constant rotating position of the third terminal (terminal projecting in direction intersecting with center axis C1 at right angles) 117 to which the wire harness is connected, it is necessary that a rotation angle of the third connector constituent body 107 around the center axis C1 is constant.

Since the plurality of second terminals 109 of the second connector constituent body 103 and the plurality of first terminals 113 of the first connector constituent body 105 are provided, when the first connector constituent body 105 is installed to the second connector constituent body 103 attached to the cylinder head 102, it is necessary to appropriately rotate the first connector constituent body 105 around the center axis C1 and to bond the plurality of second terminals 109 of the second connector constituent body 103 to the plurality of first terminals 113 of the first connector constituent body 105, respectively.

Due to this need, the first connector constituent body 105 can rotate around the center axis C1 within a predetermined angle (e.g., ±180°) with respect to the third connector constituent body 107. Further, there is provided a rotating and positioning mechanism which engages the first connector constituent body 105 with the second connector constituent body 103 to rotate and position the first connector constituent body 105 when the first connector constituent body 105 and the third connector constituent body 107 are installed to the second connector constituent body 103 which is attached to the cylinder head 102.

The connector 101 of the second embodiment is also provided with the rotating and positioning mechanism which is similar to the connector 1 of the first embodiment. According to this, the first connector constituent body 105 is guided by the second connector constituent body 103, and the first connector constituent body 105 is positioned at a regular fitting position with respect to the second connector constituent body 103. The rotating and positioning mechanism will be described later.

As illustrated in FIG. 10 and the like, the second connector constituent body 103 includes the first cylindrical portion 121, the second cylindrical portion 141 and a bottom wall 143. An outer diameter of the second cylindrical portion 141 is equal to that of the first cylindrical portion 121, and an inner diameter of the second cylindrical portion 141 is slightly larger than that of the first cylindrical portion 121. The center axis C1 of the second cylindrical portion 141 and the center axis C1 of the first cylindrical portion 121 match with each other, and the second cylindrical portion 141 is connected to an upper side of the first cylindrical portion 121.

An induction rail surface 145 as the rotating and positioning mechanism is formed on an upper end of the first cylindrical portion 121 of the second connector constituent body 103 like the induction rail surface 15 of the connector 1 of the first embodiment (see FIG. 10). The induction rail surface 145 has a cut surface shape when an upper side of a cylindrical element configuring the first cylindrical portion 121 is cut at a plane diagonally intersecting the center axis C1.

The induction rail surface 145 is the lowest on the side of one end side in the second radial direction (front side of paper sheet of FIG. 10 and the like), and is the highest on the side of the other end side in the second radial direction (deep side of the paper sheet of FIG. 10 and the like).

The bottom wall 143 closes a lower end of the first cylindrical portion 121 of the second connector constituent body 103. An inner side of the first cylindrical portion 121 of the second connector constituent body 103 forms a terminal fitting chamber, and the second terminal 109 projects upward from the bottom wall 143.

A male screw (not shown) for attaching the second connector constituent body 103 to the cylinder head 102 is formed on a lower side of the bottom wall 143. An ignition device such as a glow plug is provided in the male screw.

The through holes 129 configuring the locking portion 111 are provided, for example, in pairs. The pair of through holes 129 is disposed symmetrically with respect to the center axis C1 on the upper side of the first cylindrical portion 121 of the second connector constituent body 103. The pair of through holes 129 is disposed on the side of one end side and on the side of the other end side in the first radial direction.

Each of the through holes 129 is formed, for example, into a rectangular shape, and a C-surface 147 for guiding the locked portion 115 is formed on the through hole 129. The C-surface 147 is formed on an inner side of the first cylindrical portion 121 of the second connector constituent body 103 and on the upper side of the through hole 129.

The first cylindrical portion 121 of the second connector constituent body 103 is provided with a guide groove (not illustrated in FIGS. 6A to 14; see FIG. 2) 149 which is similar to the guide groove 16 shown in the first embodiment. The guide groove 149 is provided in one end of the second radial direction (front side of paper sheets of FIG. 10 and the like) at a location where the induction rail surface 145 becomes the lowest.

In the first radial direction, the guide groove 149 has a predetermined width and extends from the induction rail surface 145 to the bottom wall 143. In the second radial direction, the guide groove 149 has a predetermined depth, toward an outer side, from an inner surface of the first cylindrical portion 121 of the second connector constituent body 103.

The first connector constituent body 105 includes the first cylindrical portion 123 and the second cylindrical portion 125 as the first housing portion 4 as illustrated in FIG. 10 and the like. An outer diameter of the first cylindrical portion 123 is slightly smaller than an inner diameter of the first cylindrical portion 121 of the second connector constituent body 103. An outer diameter of the second cylindrical portion 125 is smaller than that of the first cylindrical portion 123. The center axis C1 of the first cylindrical portion 123 and the center axis C1 of the second cylindrical portion 125 match with each other, and the second cylindrical portion 125 is connected to an upper side of the first cylindrical portion 123.

A height of the first cylindrical portion 123 of the first connector constituent body 105 is slightly lower than a height of the first cylindrical portion 121 of the second connector constituent body 103. A height of the first connector constituent body 105 is higher than a height of the first cylindrical portion 121 of the second connector constituent body 103.

The first terminal 113 is provided in the first cylindrical portion 123 of the first connector constituent body 105 and on a lower end of the first cylindrical portion 123.

Two notches 135 are adjacently formed in the second cylindrical portion 125 of the first connector constituent body 105. The elastic arm 131 and the locked pawl 133 configuring the locked portion 115 are formed between the two notches 135. Each of the notches 135 configuring the cantilever beam shaped elastic arm 131 upwardly extends, by a predetermined length, from a lower end of the second cylindrical portion 125 of the first connector constituent body 105. According to this, a tip end of the cantilever beam shaped elastic arm 131 is located on a lower side and a base end of the elastic arm 131 is located on an upper side. The locked pawl 133 is formed on the tip end of the elastic arm 131.

The elastic arm 131 and the locked pawl 133 are provided in pairs, and they are formed on both ends in the first radial direction. Lower sides of the elastic arm 131, the locked pawl 133 and the two notches 135 (portions of first cylindrical portion 123 of first connector constituent body 105) are provided a notch 153 (see FIG. 10 and the like) having a width which is equal to an outer size value between the two notches 135.

The locked pawl 133 includes the folded back portion 137. When installing operation of the third connector constituent body 107 on the installed first connector constituent body 105 is completed, the folded back portion 137 enters the through hole 129 of the second connector constituent body 103, and the locked portion 115 is locked with the locking portion 111.

The first connector constituent body 105 is provided with an induction rib portion 159 (see FIGS. 6A and 6B and the like) like the connector 1 of the first embodiment. The induction rib portion 159 projects from a lower end of an outer periphery of the first cylindrical portion 123 of the first connector constituent body 105 and on one end side (front side of paper sheet of FIG. 10 and the like) in the second radial direction. A lower end surface of the induction rib portion 159 is formed into a semi-circular arc surface. A central portion of the semi-circular arc surface is the lowest, and its left and right sides gradually rise.

When attempt is made to install the first connector constituent body 105 on the second connector constituent body 103 which is attached to the cylinder head 102 and the first connector constituent body 105 is lowered and brought close to the second connector constituent body 103, a lower end of the induction rib portion 159 abuts against the induction rail surface 145. If the first connector constituent body 105 is further lowered, the induction rib portion 159 slides on the induction rail surface 145 as the rotating and positioning mechanism, the first connector constituent body 105 rotates around the center axis C1, the induction rib portion 159 enters an upper end of the guide groove 149, and the first connector constituent body 105 is rotated and positioned with respect to the second connector constituent body 103.

If the first connector constituent body 105 is further lowered, the plurality of second terminals 109 of the second connector constituent body 103 and the plurality of first terminals 113 of the first connector constituent body 105 are respectively bonded to each other.

If the induction rib portion 159 abuts against the induction rail surface 145, the induction rail surface 145 guides the induction rib portion 159 such that the first connector constituent body 105 comes to the regular rotating and fitting position with respect to the second connector constituent body 103 up to a fitting position before the second terminal 109 and the first terminal 113 start contacting with each other. The guide groove 149 restricts rotation of the induction rib portion 159 (first connector constituent body 105), and permits only fitting movement of the first connector constituent body 105 into the second connector constituent body 103 at the regular rotating and fitting position. If the induction rib portion 159 enters the guide groove 149, the second terminals 109 of the second connector constituent body 103 and the first terminals 113 of the first connector constituent body 105 start contacting with each other. At the fitting completion position where the induction rib portion 159 enters the guide groove 149 to its deep side (lower side), the second terminal 109 and the first terminal 113 are brought into an appropriate contact state.

As illustrated in FIG. 10 and the like, the third connector constituent body 107 includes the cylindrical portion 127, a bottom wall 161, a body 163, a mounting arm 165 and a terminal installing portion 167.

An outer diameter of the cylindrical portion 127 of the third connector constituent body 107 is slightly smaller than an inner diameter of the first cylindrical portion 121 of the second connector constituent body 103. An inner diameter of the cylindrical portion 127 of the third connector constituent body 107 is slightly larger than an outer diameter of the second cylindrical portion 125 of the first connector constituent body 105.

A height of the cylindrical portion 127 of the third connector constituent body 107 is higher than a height of the second cylindrical portion 125 of the first connector constituent body 105.

The bottom wall 161 closes an upper end of the cylindrical portion 127 of the third connector constituent body 107. The body 163 is disposed on an upper side of the bottom wall 161. The mounting arm 165 projects from the body 163 toward one end side in the first radial direction. The terminal installing portion 167 is disposed on an upper side of the body 163. The third terminal 117 is provided in the terminal installing portion 167. The terminal installing portion 167 opens toward one end side in the second radial direction. A wire harness installed the terminal installing portion 167 (third terminal 117) extends toward one end side in the second radial direction.

The cylinder head 102 is provided with a recess 173 which opens upward. A portion of the connector 101 attached to the cylinder head 102 which is higher than the mounting arm 165 including the mounting arm 165 projects upward from the recess 173, and a portion of the connector 101 lower than the mounting arm 165 exists in the recess 173.

A female screw (not shown) with which a male screw (not shown) of the second connector constituent body 103 is threadedly engaged is provided in a bottom surface of the recess 173 of the cylinder head 102 like the first embodiment.

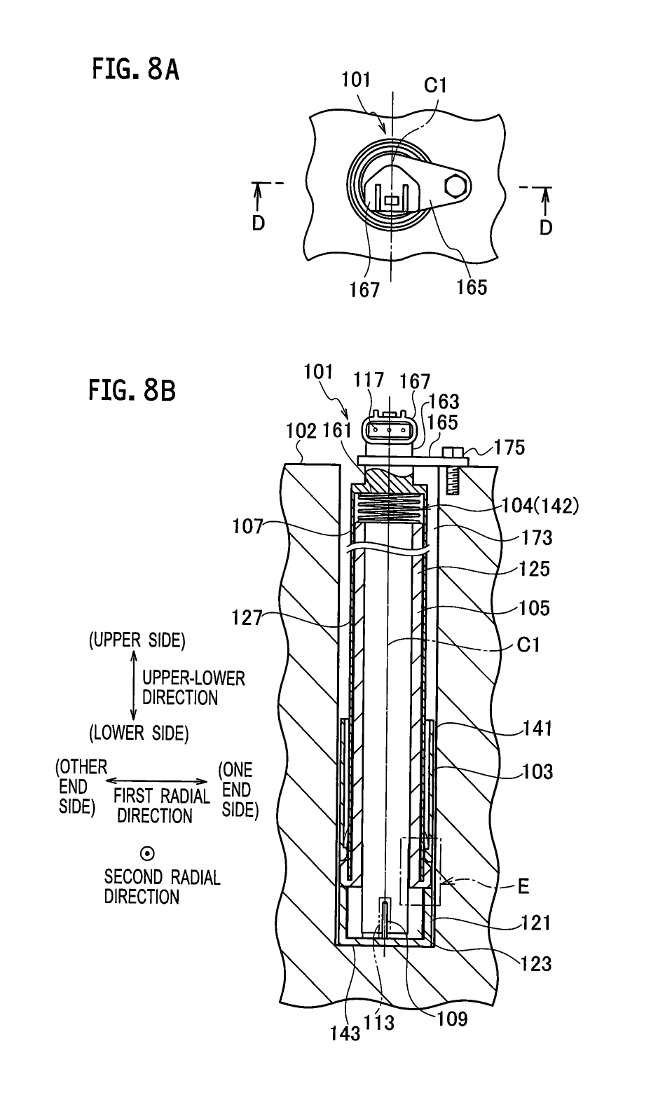

If the connector 101 is attached to the cylinder head 102, the mounting arm 165 comes into contact with a portion of the cylinder head 102 in the vicinity of the recess 173. The mounting arm 165 (third connector constituent body 107) is fixed to the cylinder head 102 by a fastening member such as a mounting screw (bolt) 175 and the like (see FIGS. 8A and 8B and the like). According to this, the cylinder head 102 and the third connector constituent body 107 are integrally fixed to each other.

In a state before the first connector constituent body 105 is installed to the second connector constituent body 103 which is attached to the cylinder head 102, the first connector constituent body 105 and the third connector constituent body 107 are connected to each other through an electric wire (not shown).

This will further be described. As illustrated in FIG. 10, in the first connector constituent body 105, the second cylindrical portion 125 is located on the upper side and the first cylindrical portion 123 is located on the lower side. The cylindrical portion 127 of the third connector constituent body 107 opens downward, and the second cylindrical portion 125 of the first connector constituent body 105 enters the cylindrical portion 127 of the third connector constituent body 107. The elastic body (e.g., compression coil spring) 142 as the biasing member 104 is provided in the bottom wall 161 of the third connector constituent body 107 between an upper end of the second cylindrical portion 125 of the first connector constituent body 105 and the bottom wall 161 of the third connector constituent body 107. The first connector constituent body 105 is biased downward by the elastic body 142 against the third connector constituent body 107. A lower end of the cylindrical portion 127 of the third connector constituent body 107 is slightly separated from the locked pawl 133 above the locked pawl 133 which configures the locked portion 115 of the first connector constituent body 105.

An electric wire which is not illustrated in FIG. 10 and the like passes through an interior of the cylindrical portion 127 of the third connector constituent body 107 and an interior of the second cylindrical portion 125 of the first connector constituent body 105, and the electric wire connects the first terminal 113 and the third terminal 117 with each other.

The first connector constituent body 105 and the third connector constituent body 107 are also provided with rotation-restricting portions (not shown) which are similar to the rotation-restricting portions 8a and 8b of the connector 1 of the first embodiment. According to this, a rotation amount of the first connector constituent body 105 around the center axis C1 with respect to the third connector constituent body 107 is limited to a value within ±180° for example, and an electric wire is prevented from being excessively twisted.

In the above description, the elastic arm 131 does not bend in a state where no external force is applied, the elastic arm 131 elastically deforms inward in a halfway state where the first connector constituent body 105 is installed to the second connector constituent body 103, and when installing operation of the first connector constituent body 105 on the second connector constituent body 103 is completed, the elastic arm 131 restores, and the locked portion 115 is locked with the locking portion 111. However, it is not absolutely necessary to configure the connector in this manner.

For example, it is also possible to employ such a configuration that the elastic arm 131 bends inward in a state where no external force is applied, the elastic arm 131 elastically deforms outward by the locked portion-holding portion 119 when the third connector constituent body 107 is installed to the first connector constituent body 105 which is installed to the second connector constituent body 103, and the locked portion 115 is locked with the locking portion 111.

Next, assembling operation to install the first connector constituent body 105 and the third connector constituent body 107 to the second connector constituent body 103 which is attached to the cylinder head 102 will be described.

As illustrated in FIG. 10 and the like, an initial state shall be as follows: i.e., the first connector constituent body 105 and the third connector constituent body 107 separate from the second connector constituent body 103 and are located above the second connector constituent body 103. In the initial state, the center axes C1 of the connector constituent bodies 103, 105 and 107 shall match with each other.

In the initial state, the first connector constituent body 105 and the third connector constituent body 107 are lowered. Except when the first connector constituent body 105 is inserted into the second connector constituent body 103 at the regular rotating and fitting position, the induction rib portion 159 of the first connector constituent body 105 abuts against an arbitrary position of the induction rail surface 145 of the second connector constituent body 103. If the induction rib portion 159 slides on the induction rail surface 145, the first connector constituent body 105 appropriately rotates around the center axis C1 with respect to the second connector constituent body 103. In this manner, the first connector constituent body 105 is brought into a rotating position where the induction rib portion 159 is located at the lowermost position of the induction rail surface 145. According to this, the first connector constituent body 105 and the second connector constituent body 103 are brought into the regular rotating and fitting positions.

As illustrated in FIGS. 11, 12 and the like, the elastic arm 131 elastically deforms inward by a reaction force received from the second connector constituent body 103.

Subsequently, if the first connector constituent body 105 and the third connector constituent body 107 are further lowered and fitting motion therebetween proceeds, the induction rib portion 159 starts entering the straight guide groove 149. Thereafter, the second terminal 109 and the first terminal 113 start bonding to each other, the locked portion-holding portion 119 and the locked portion 115 start engaging with each other, and the locking portion 111 and the locked portion 115 start engaging with each other.

As illustrated in FIG. 13, the first connector constituent body 105 is lowered until a lower end of the first connector constituent body 105 abuts against the bottom wall 143 of the second connector constituent body 103. In accordance with this abutment, the locked pawl 133 configuring the locked portion 115 enters the through hole 129 of the second connector constituent body 103 configuring the locking portion 111, the locked portion 115 is locked with the locking portion 111, the first connector constituent body 105 is integrally installed to the second connector constituent body 103, and the elastic arm 131 restores. The induction rib portion 159 enters the guide groove 149, the first connector constituent body 105 does not rotate around the center axis C1, but is only lowered. If the lower end of the first connector constituent body 105 abuts against the bottom wall 143 of the second connector constituent body 103, installing operation of the first connector constituent body 105 on the second connector constituent body 103 is completed.

When the first connector constituent body 105 starts fitting into the second connector constituent body 103 at the regular rotating and fitting position, the induction rib portion 159 directly enters the guide groove 149 without sliding on the induction rail surface 145.

Subsequently, to adjust a direction of the third terminal 117, the third connector constituent body 107 is appropriately rotated and positioned with respect to the first connector constituent body 105, and the third connector constituent body 107 is fixed to the cylinder head 102 using a bolt 175.

According to this, the third connector constituent body 107 is installed to the attached first connector constituent body 105, and the cylinder head 102, the second connector constituent body 103, the first connector constituent body 105 and the third connector constituent body 107 are integrally connected to each other.

According to the connector 101 of the second embodiment, when the third connector constituent body 107 is installed to the installed first connector constituent body 105, the locked portion-holding portion 119 of the third connector constituent body 107 maintains the state where the locked portion 115 is locked with the locking portion 111. Therefore, the first connector constituent body 105 is restricted and fixed by the second connector constituent body 103. Hence, even if vibration is applied in a state where the first connector constituent body 105 and the third connector constituent body 107 are installed to the second connector constituent body 103, the bonded state between the connector constituent bodies 103, 105 and 107 is not easily released, and the fitted state between the second terminal 109 and the first terminal 113 can be ensured. Further, it is possible to suppress generation of sliding motion of contacts between the second terminal 109 and the first terminal 113, and vibration resistance and electric contact properties are enhanced.

According to the connector 101 of the second embodiment, like the connector 1 of the first embodiment, it is possible to simplify the configuration as compared with the connector 90 (see FIG. 24) of the second conventional example described in Patent Literature US 2010/0003841 A1.

That is, in the connector 90 of the second conventional example, the contact parts 91, 92 and 93 are formed into a multi-contact structure for measurement against vibration, its configuration is complicated, and it is difficult to guarantee fitting phenomenon and the connector 90 is expensive. On the other hand, in the connector 101 of the second embodiment, the multi-contact structure is not employed, the configuration is simple, and it is possible to reduce costs.

According to the connector 101 of the second embodiment, the elastic arm 131 is pushed by the second connector constituent body 103 and is elastically deformed inward in the halfway state where the first connector constituent body 105 is installed to the second connector constituent body 103, and in a state where the installing operation of the first connector constituent body 105 on the second connector constituent body 103 is completed, the elastic arm 131 restores. Hence, an operator can easily recognize that the installing operation of the first connector constituent body 105 on the second connector constituent body 103 is completed.

According to the connector 101 of the second embodiment the first connector constituent body 105 is biased by the elastic body 142 toward the second connector constituent body 103 and is connected. Therefore, vibration resistance and electric contact properties are enhanced.

### Third Embodiment

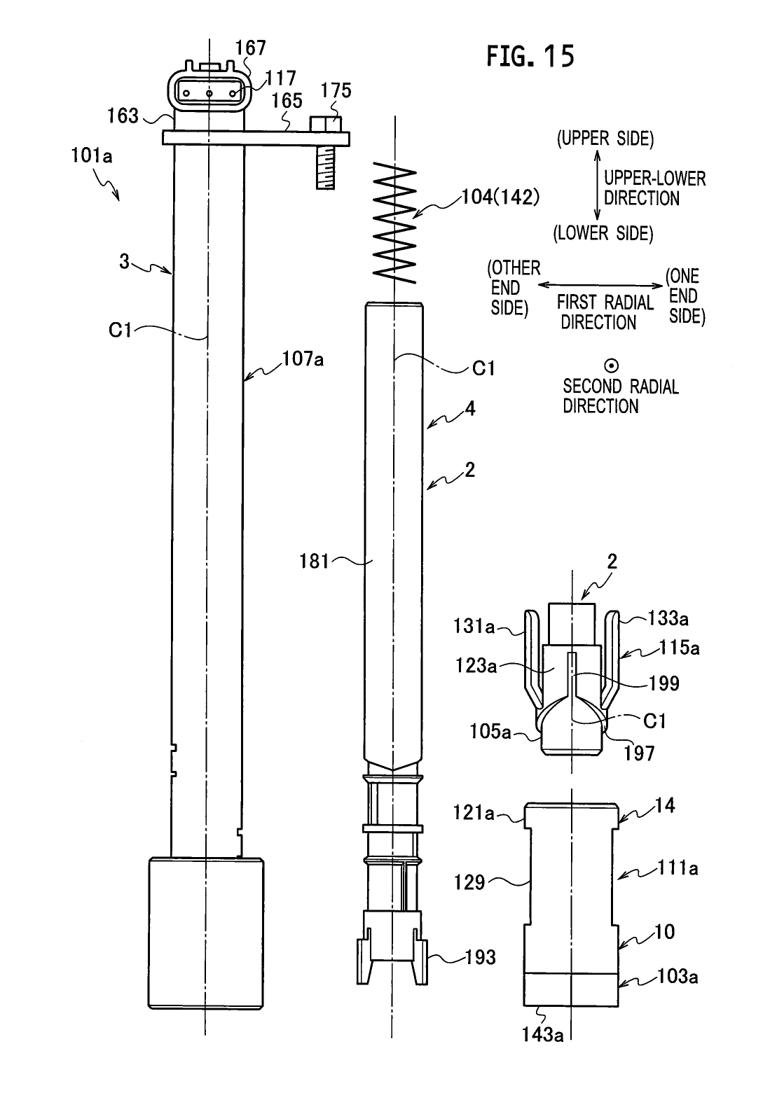

FIGS. 15 to 23 illustrate a third embodiment. In a connector 101a of the third embodiment, configurations of an locking portion 111a, an locked portion 115a and an locked portion-holding portion 119a are different from those of the connector 101 of the second embodiment. Other configurations of the third embodiment are substantially the same as those of the connector 101 of the second embodiment, and the third embodiment exerts substantially the same effects as the second embodiment.

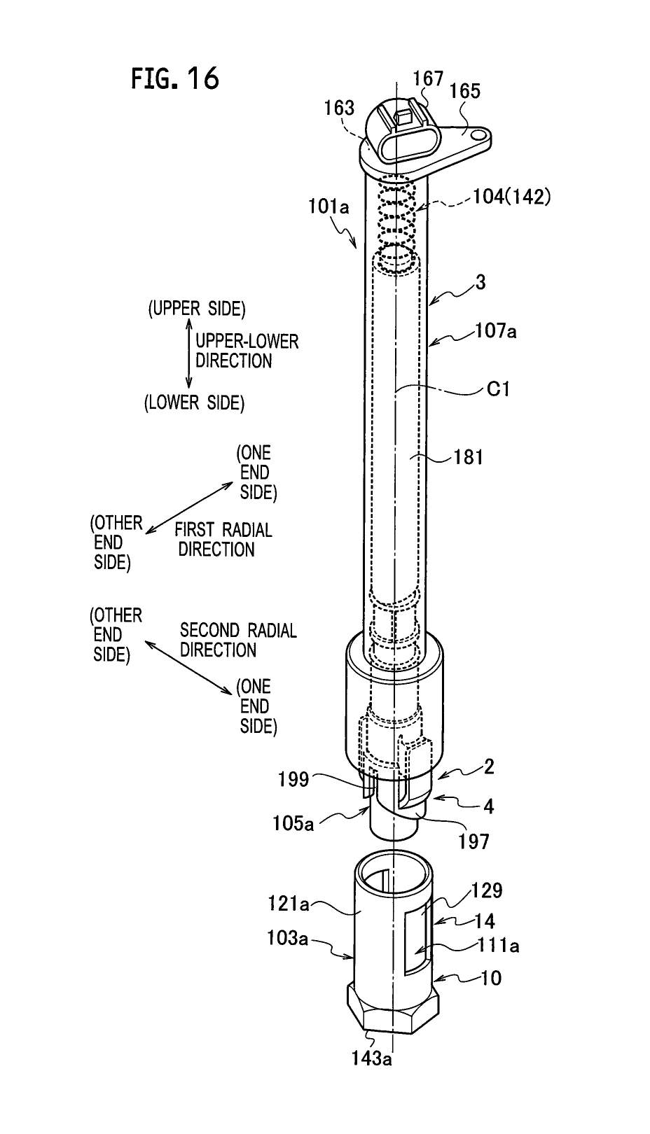

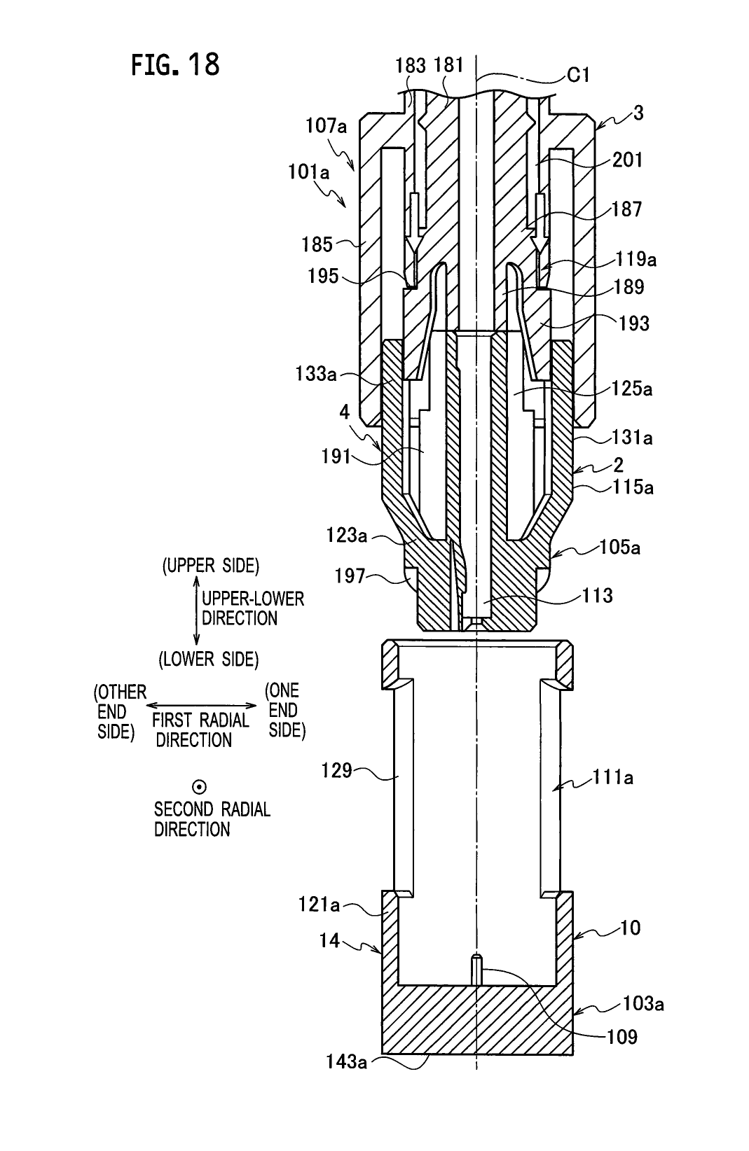

As illustrated in FIGS. 16, 18 and the like, the connector 101a of the third embodiment includes a first connector portion 2, a second connector portion 10, and a body portion 3.

The first connector portion 2 includes the locked portion 115a. The second connector portion 10 includes the locking portion 111a. The body portion 3 includes the locked portion-holding portion 119a.

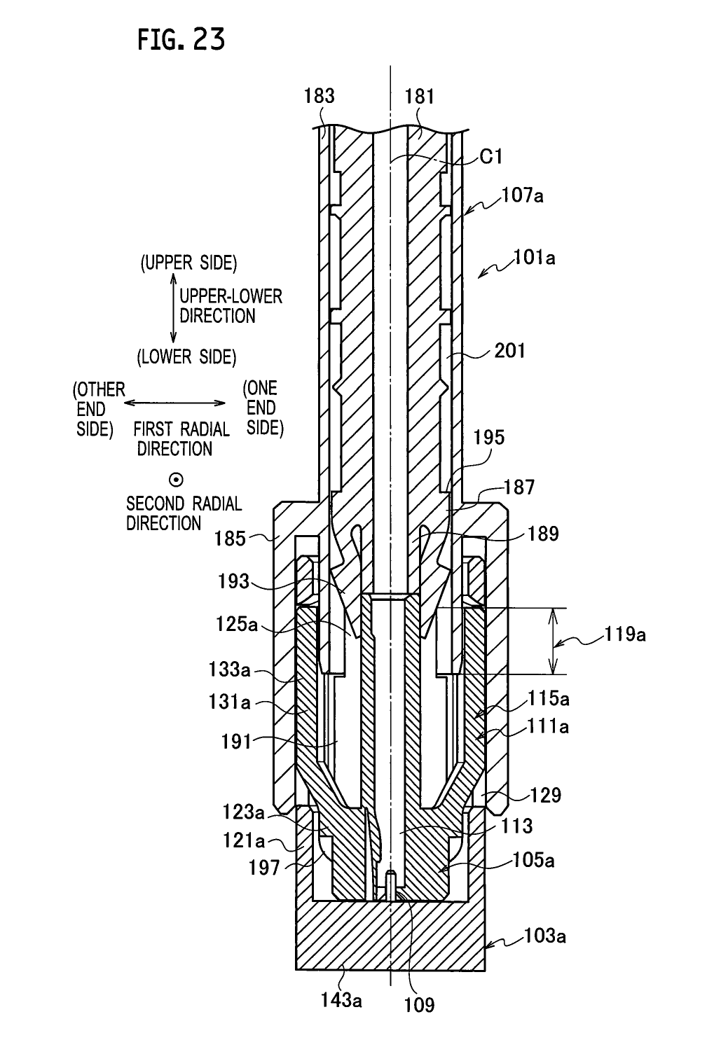

As illustrated in FIG. 23 and the like, when the first connector portion 2 is installed to the second connector portion 10, the locked portion 115a is locked with the locking portion 111a, and the locked portion-holding portion 119a maintains the state where the locked portion 115a is locked with the locking portion 111a.

The connector 101a is provided with a biasing member 104 which gives a force to maintain a fitted state between the first connector portion 2 and the second connector portion 10 when the first connector portion 2 is installed to the second connector portion 10.

The first connector portion 2 includes a first connector constituent body 105a as a first housing portion 4 and a fourth connector constituent body 181. The second connector portion 10 includes a second connector constituent body 103a as a second housing portion 14. The body portion 3 includes a third connector constituent body 107a.

The first connector constituent body 105a includes a first cylindrical portion 123a provided with a first terminal 113 therein. The second connector constituent body 103a includes a cylindrical portion 121a provided with a second terminal 109 therein.

An inner diameter of the cylindrical portion 121a of the second connector constituent body 103a is slightly larger than an outer diameter of the first cylindrical portion 123a of the first connector constituent body 105a. In a state where the first connector constituent body 105a is installed to the second connector constituent body 103a, the first cylindrical portion 123a of the first connector constituent body 105a enters and is fitted into the cylindrical portion 121a of the second connector constituent body 103a.

The first connector constituent body 105a includes a second cylindrical portion 125a. An outer diameter of the second cylindrical portion 125a is smaller than that of the first cylindrical portion 123a of the first connector constituent body 105a.

The third connector constituent body 107a includes a first cylindrical portion 183 and a second cylindrical portion 185. An outer diameter of the first cylindrical portion 183 is substantially equal to that of the first cylindrical portion 123a of the first connector constituent body 105a, and an inner diameter of the first cylindrical portion 183 is larger than an outer diameter of the second cylindrical portion 125a of the first connector constituent body 105a. An inner diameter of the second cylindrical portion 185 is slightly larger than an outer diameter of the cylindrical portion 121a of the second connector constituent body 103a.

The fourth connector constituent body 181 includes a first cylindrical portion 187 and a second cylindrical portion 189. An outer diameter of the first cylindrical portion 187 is slightly smaller than an inner diameter of the first cylindrical portion 183 of the third connector constituent body 107a. An outer diameter of the second cylindrical portion 189 is smaller than the second cylindrical portion 125a of the first connector constituent body 105a.

The locking portion 111a is composed of through holes 129 provided in the cylindrical portion 121a of the second connector constituent body 103a. The locking portion 111a may not be the through holes 129 or be composed of the through holes 129 and a recess. That is, the locking portion 111a may be composed of at least one of the through hole 129 and the recess provided in the cylindrical portion 121a of the second connector constituent body 103a.

The locked portion 115a includes a first elastic arm 131a and an locked pawl 133a. The first elastic arm 131a projects from the first cylindrical portion 123a of the first connector constituent body 105a. According to this, the first elastic arm 131a is formed into a cantilever beam shape. In a state where no external force is applied to the first elastic arm 131a, an outer size of the first elastic arm 131a is slightly smaller than an inner diameter of the second cylindrical portion 185 of the third connector constituent body 107a and an outer diameter of the cylindrical portion 121a of the second connector constituent body 103a. An inner size of the first elastic arm 131a is slightly larger than an outer diameter of the first cylindrical portion 183 of the third connector constituent body 107a.

Here, an outer size of the first connector constituent body 105a is an outer diameter of an envelope (envelope circle centering on center axis C1 of first cylindrical portion 123a of first connector constituent body 105a) defined by a location (end) existing on an outermost side of the first elastic arm 131a.

For example, when three elastic arms 131a are provided and these elastic arms 131a are disposed at point-symmetric positions with respect to the center axis C1 of the first cylindrical portion 123a of the first connector constituent body 105a, the outer size of the first connector constituent body 105a is an outer diameter of an envelope circle which is in contact with an end existing on an outermost side of each of the first elastic arms 131a.

Similarly, an inner size of the first connector constituent body 105a is an inner diameter of an envelope defined by a location (end) existing on an innermost side of the first elastic arm 131a. However, as illustrated in FIG. 18, as the first elastic arm 131a, only a tip end side portion (upper side portion) of the first connector constituent body 105a extending in the upper-lower direction in FIG. 18 is considered, and a portion of the elastic arm 131a diagonally extending from the first cylindrical portion 123a of the first connector constituent body 105a in the vicinity of the first cylindrical portion 123a of the first connector constituent body 105a shall be removed.

A notch 191 is provided in the first cylindrical portion 123a and the second cylindrical portion 125a of the first connector constituent body 105a so that the first elastic arm 131a can bend inward. The locked pawl 133a is composed of a tip end side portion (tip end side portion extending in upper-lower direction in FIG. 18) of the first elastic arm 131a.

Second elastic arms 193 project in a cantilever beam form from the first cylindrical portion 187 of the fourth connector constituent body 181. As illustrated in FIG. 18 and the like, an outer size of each of the second elastic arms 193 is substantially equal to an outer diameter of the first cylindrical portion 123a of the first connector constituent body 105a. An inner size of the second elastic arm 193 is larger than an outer diameter of the second cylindrical portion 189 of the fourth connector constituent body 181.

Since the inner size of the second elastic arm 193 is larger than the outer diameter of the second cylindrical portion 189 of the fourth connector constituent body 181 and since the first cylindrical portion 123a and the second cylindrical portion 125a of the first connector constituent body 105a are provided with the notch 191, the second elastic arm 193 can also elastically deform inward.

A step 195 is provided on an outer side of the second elastic arm 193, and the first cylindrical portion 183 of the third connector constituent body 107a abuts against the step 195. A portion (tip end) of the first cylindrical portion 183 of the third connector constituent body 107a configures the locked portion-holding portion 119a.

As illustrated in FIG. 18 and the like, in a state before the first connector constituent body 105a, the third connector constituent body 107a and the fourth connector constituent body 181 are installed to the second connector constituent body 103a (initial state), an end (lower end) of the second cylindrical portion 189 of the fourth connector constituent body 181 abuts against an end (upper end) of the second cylindrical portion 125a of the first connector constituent body 105a to form a first abutment location. Further, an end (lower end) of the first cylindrical portion 183 of the third connector constituent body 107a abuts against the step 195 of the second elastic arm 193 to form a second abutment location. A tip end (lower end) of the second elastic arm 193 enters the tip end (upper end) of the first elastic arm 131a and abuts against the first elastic arm 131a.

In a halfway state where the first connector constituent body 105a, the third connector constituent body 107a and the fourth connector constituent body 181 are installed to the second connector constituent body 103a, if the third connector constituent body 107a is brought close to the second connector constituent body 103a, the first connector constituent body 105a moves toward the second connector constituent body 103a through the first abutment location and the second abutment location (fourth connector constituent body 181, through abutment location between end of first cylindrical portion 183 of third connector constituent body 107a and step 195 of the second elastic arm 193, and abutment location between an end of second cylindrical portion 189 of fourth connector constituent body 181 and end of second cylindrical portion 125a of first connector constituent body 105a).

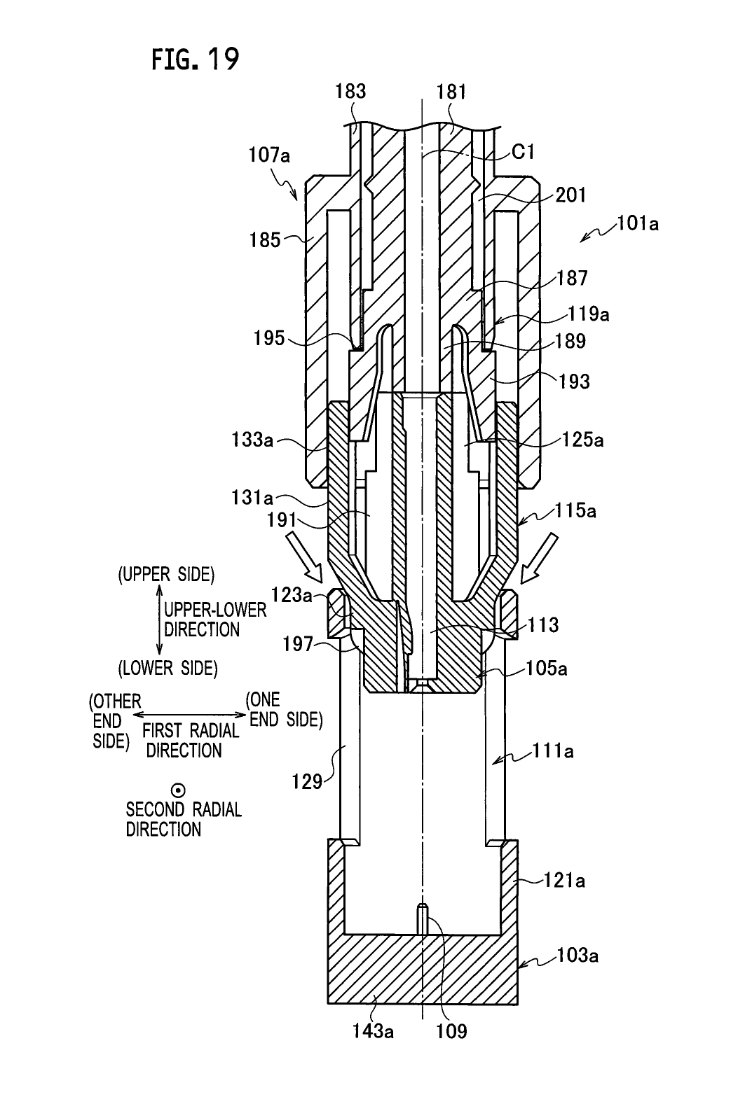

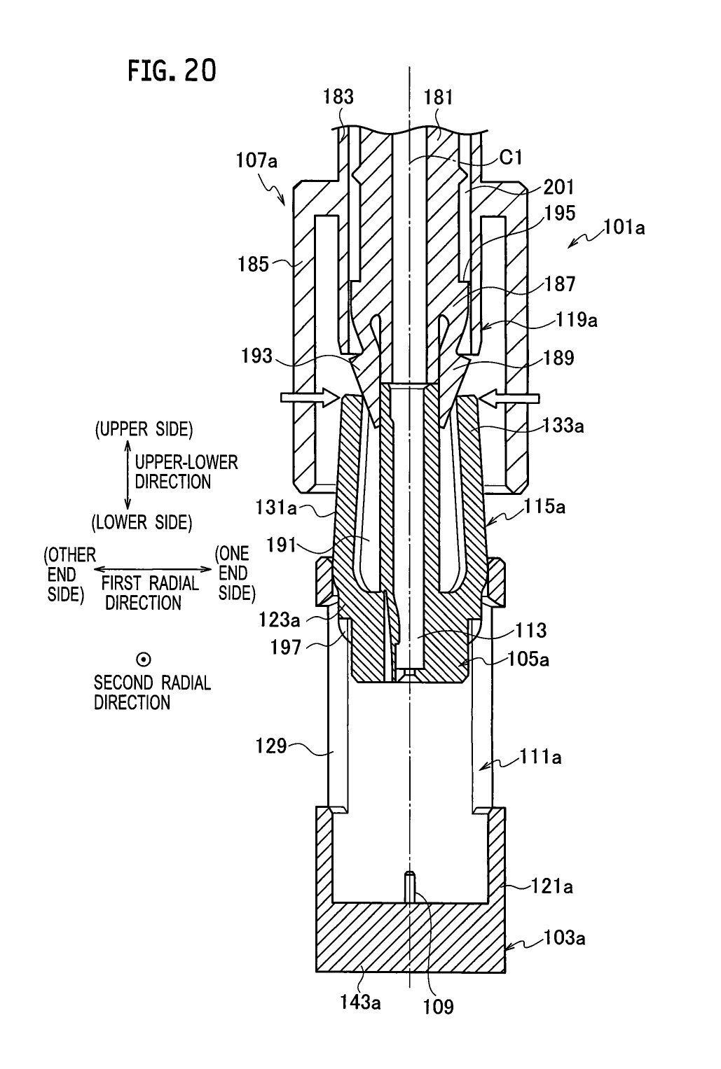

As illustrated in FIGS. 19 to 20 and the like, the first connector constituent body 105a enters the cylindrical portion 121a of the second connector constituent body 103a, and the first elastic arm 131a elastically deforms inward by a reaction force received from the cylindrical portion 121a of the second connector constituent body 103a until an outer size of the first elastic arm 131a becomes equal to an inner diameter of the cylindrical portion 121a of the second connector constituent body 103a.

An inward force is applied to the second elastic arm 193 by the elastic deformation of the first elastic arm 131a, an outer size of the second elastic arm 193 becomes smaller than the first cylindrical portion 183 of the third connector constituent body 107a, and the second elastic arm 193 elastically deforms inward until the abutment at the second abutment location is released (until abutment of end of first cylindrical portion 183 of third connector constituent body 107a against step 195 of second elastic arm 193 is released).

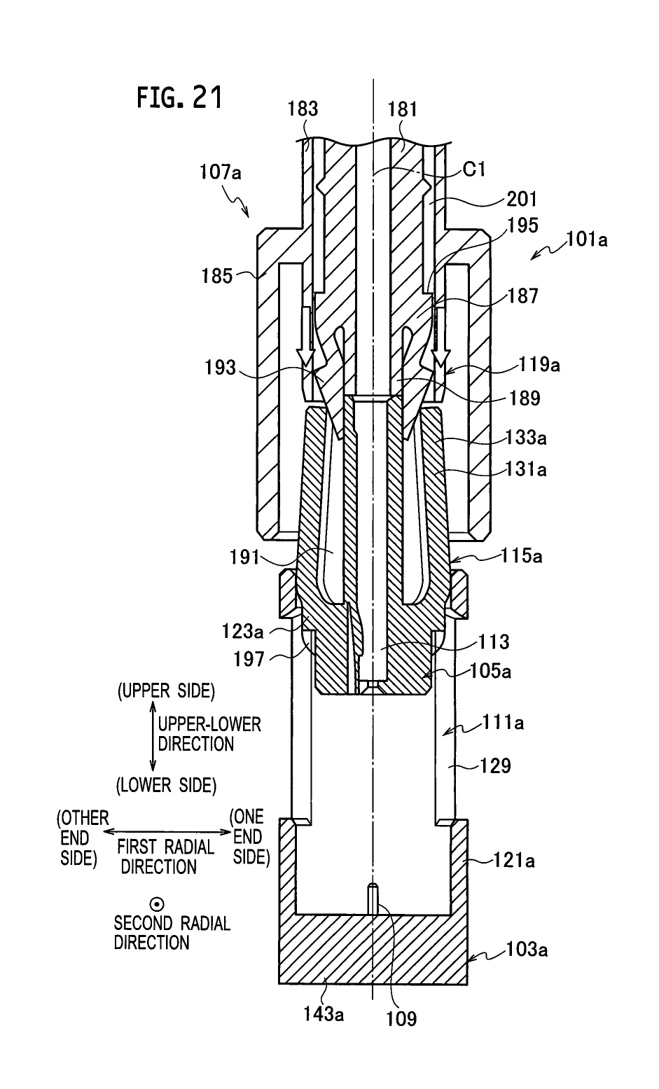

After the second elastic arm 193 is elastically deforms, the third connector constituent body 107a is brought close to the second connector constituent body 103a. According to this, an end (lower end) of the first cylindrical portion 183 of the third connector constituent body 107a abuts against a tip end (upper end) of the first elastic arm 131a and a third abutment location is formed as illustrated in FIG. 21.

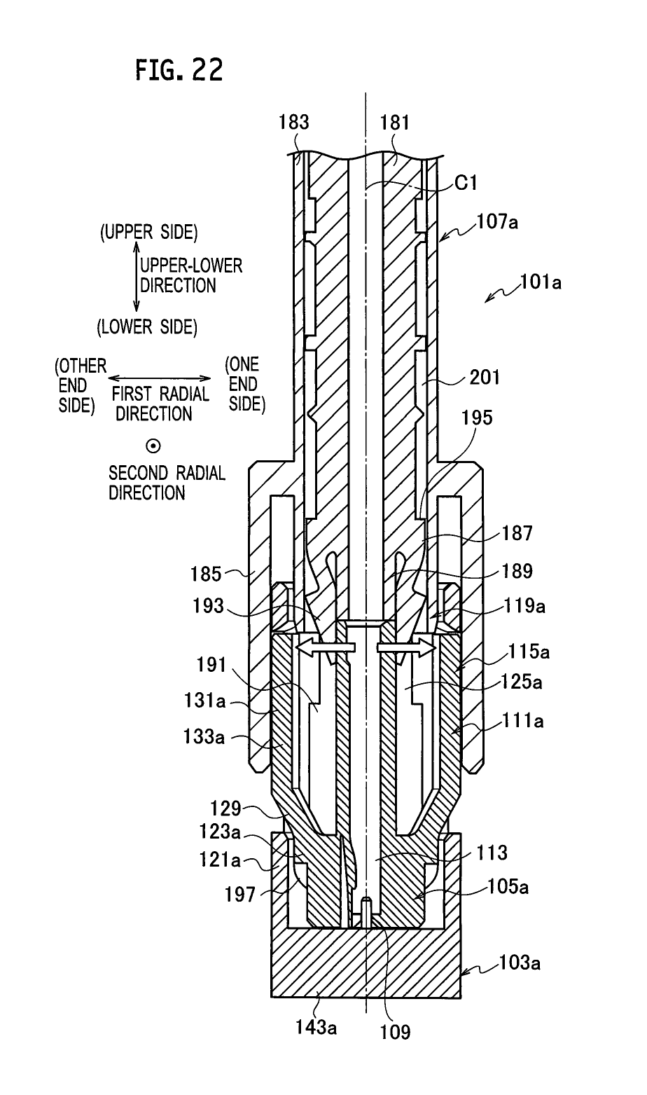

After the third abutment location is formed, the third connector constituent body 107a is brought close to the second connector constituent body 103a. According to this, the first connector constituent body 105a further enters the cylindrical portion 121a of the second connector constituent body 103a through the third abutment location (abutment location between end of second cylindrical portion 185 of third connector constituent body 107a and tip end of first elastic arm 131a), and the locked pawl 133a (locked portion 115a) composed of the tip end of the first elastic arm 131a enters the through hole 129 (locking portion 111a) of the second connector constituent body 103a (see FIG. 22).

In a state where the first connector constituent body 105a, the third connector constituent body 107a and the fourth connector constituent body 181 have been installed to the second connector constituent body 103a (a state which is formed by entering the engaged portion 115a to the engaging portion 111a, being locked, and bringing the third connector constituent body 107a close to the second connector constituent body 103a after locking), the first cylindrical portion 183 of the third connector constituent body 107a enters the first elastic arm 131a as illustrated in FIG. 23, the first elastic arm 131a and the cylindrical portion 121a of the second connector constituent body 103a enters the second cylindrical portion 185 of the third connector constituent body 107a, and the locked portion-holding portion 119a maintains a state where the locked portion 115a is locked with the locking portion 111a.

The biasing member 104 is composed of an elastic body (e.g., compression coil spring) 142 as a biasing member 104 provided between the first connector constituent body 105a and the fourth connector constituent body 181. In a state where the first connector constituent body 105a, the third connector constituent body 107a and the fourth connector constituent body 181 have been installed to the second connector constituent body 103a, the elastic body 142 biases the first connector constituent body 105a toward the second connector constituent body 103a.

The connector 101a of the third embodiment will be described in more detail. For the purpose of illustration, as in the second embodiment, an extending direction of the center axes C1 of the cylindrical portions 121a, 123a, 125a, 183, 185, 187 and 189 is defined as a upper-lower direction, predetermined one direction which intersects with the upper-lower direction at right angles is defined as a first radial direction, and predetermined another direction which intersects with the upper-lower direction and the first radial direction at right angles is defined as a second radial direction.

Like the first connector constituent body 105 of the second embodiment, the first connector constituent body 105a is integrally attached to the cylinder head 102 by a male screw (not shown).

Like the connector 101 of the second embodiment, the second connector constituent body 103a can rotate (e.g., ±180°) around the center axis C1 with respect to the third connector constituent body 107a. Like the connector 101 of the second embodiment, there is provided with a rotating and positioning mechanism which engages the first connector constituent body 105a with the second connector constituent body 103a to rotate and position the first connector constituent body 105a when the first connector constituent body 105a and the third connector constituent body 107a are installed to the second connector constituent body 103a which is attached to the cylinder head 102. The rotating and positioning mechanism will be described later.

As illustrated in FIG. 18 and the like, the second connector constituent body 103a includes the cylindrical portion 121a and a bottom wall 143a. The bottom wall 143a closes a lower end of the cylindrical portion 121a of the second connector constituent body 103a. An inner side of the cylindrical portion 121a of the second connector constituent body 103a forms a terminal fitting chamber. The second terminal 109 projects upward from the bottom wall 143a.

A male screw (not shown) for attaching the second connector constituent body 103a to the cylinder head 102 is formed on a lower side of the bottom wall 143a. An ignition device such as a glow plug is provided in the male screw.

The through holes 129 configuring the locking portion 111a are provided in the cylindrical portion 121a of the second connector constituent body 103a, and penetrate a thick portion of the cylindrical portion 121a. Each of the through holes 129 is formed into a thin and long rectangular shape, a width direction (predetermined narrow width direction) of the through hole 129 matches with the second radial direction, and the through hole 129 extends long in the upper-lower direction of the cylindrical portion 121a of the second connector constituent body 103a.

There are provided a plurality of (e.g., three) through holes 129, and the through holes 129 are disposed such that they divide a circumference of the cylindrical portion 121a into three. In FIGS. 15 to 17B, two through holes 129 are illustrated to simplify the drawings.

As illustrated in FIG. 18 and the like, the first connector constituent body 105a includes the first cylindrical portion 123a and the second cylindrical portion 125a.

An outer diameter of the first cylindrical portion 123a of the first connector constituent body 105a is slightly smaller than an inner diameter of the cylindrical portion 121a of the second connector constituent body 103a. An outer diameter of the second cylindrical portion 125a of the first connector constituent body 105a is smaller than that of the first cylindrical portion 123a.

A sum of a size in the upper-lower direction of the first cylindrical portion 123a of the first connector constituent body 105a and a size in the upper-lower direction of the second cylindrical portion 125a of the first connector constituent body 105a is smaller than a size in the upper-lower direction of the cylindrical portion 121a of the second connector constituent body 103a. The center axes C1 of the cylindrical portions 123a and 125a match with each other.

The second cylindrical portion 125a is connected to an upper side of the first cylindrical portion 123a of the first connector constituent body 105a. The first terminal 113 is provided in the first cylindrical portion 123a of the first connector constituent body 105a and on a lower end of the first cylindrical portion 123a.

An induction rail surface 197 and a guide groove 199 are formed on and in a lower side of the first cylindrical portion 123a of the first connector constituent body 105a. The induction rail surface 197 is a rotating and positioning mechanism which is a cylindrical notch, and a lower end surface of the induction rail surface 197 is diagonally cut. In the third embodiment, an induction rib (not shown) is provided on an inner surface of the second connector constituent body 103a.

The locked portion 115a is composed of the locked pawl 133a which is a tip end portion of the first elastic arm 131a. The first elastic arm 131a projects upward from an intermediate portion of the first cylindrical portion 123a in the upper-lower direction. An upper end of the first elastic arm 131a is located slightly lower than an upper end of the second cylindrical portion 125a.

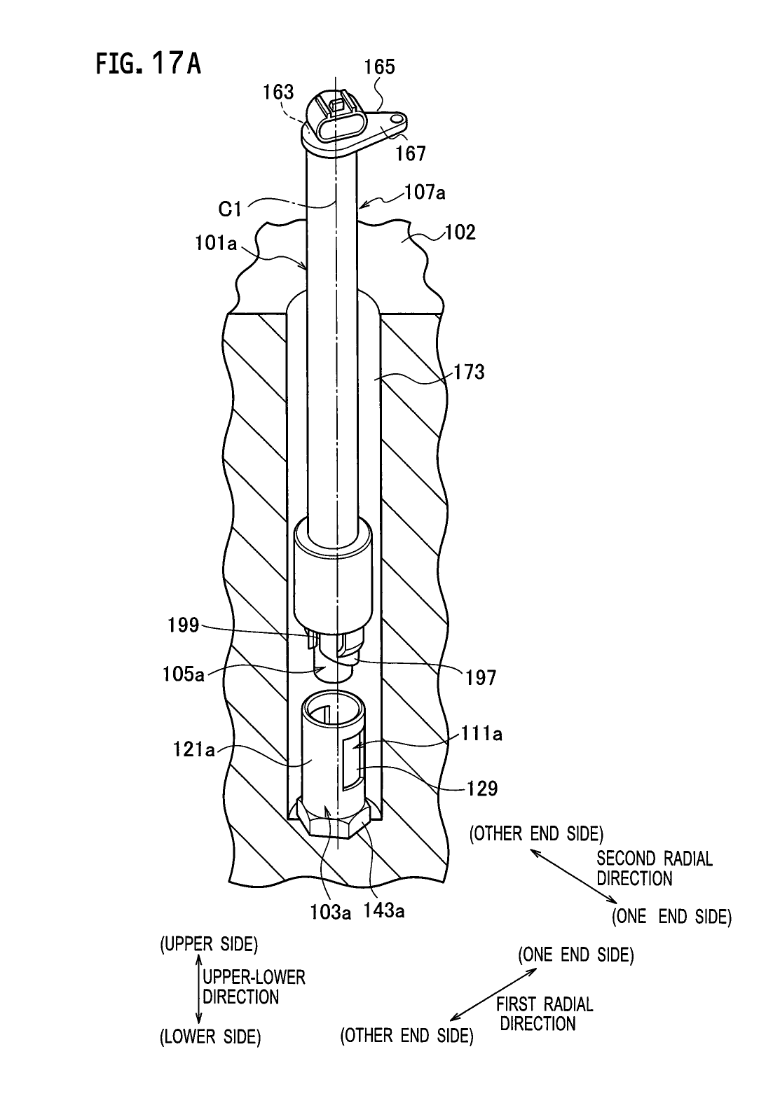

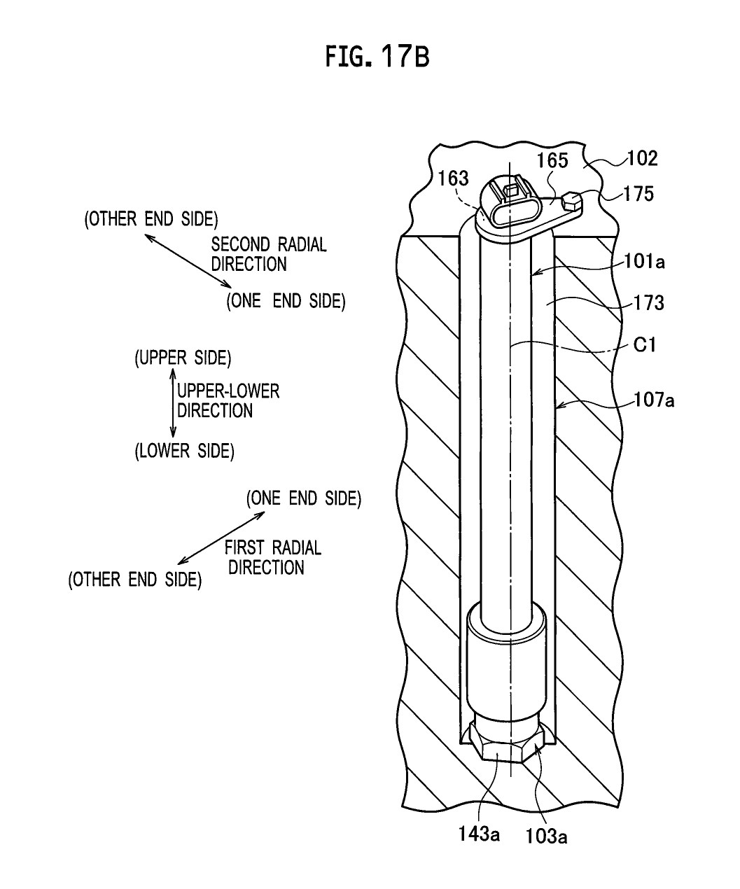

The plurality of (e.g., three) first elastic arms 131a are provided like the through holes 129, and the first elastic arms 131a are disposed such that they divide a circumference of the first cylindrical portion 123a and the like into three. In FIGS. 16 to 17B, two first elastic arms 131a are illustrated to simplify the drawings.

As illustrated in FIGS. 15, 18 and the like, the third connector constituent body 107a includes the first cylindrical portion 183, the second cylindrical portion 185, a body 163, a mounting arm 165 and a terminal installing portion 167.

As illustrated in FIG. 18 and the like, an outer diameter of the first cylindrical portion 183 of the third connector constituent body 107a is substantially equal to that of the first cylindrical portion 123a of the first connector constituent body 105a. An inner diameter of the second cylindrical portion 185 of the third connector constituent body 107a is slightly larger than an outer diameter of the cylindrical portion 121a of the second connector constituent body 103a. The center axis C1 of the first cylindrical portion 183 and the center axis C1 of the second cylindrical portion 185 match with each other.

A size in the upper-lower direction of the second cylindrical portion 185 of the third connector constituent body 107a is larger than that of the first elastic arm 131a and is smaller than that of the cylindrical portion 121a of the second connector constituent body 103a.

A size in the upper-lower direction of the first cylindrical portion 183 of the third connector constituent body 107a is larger than that of the second cylindrical portion 185.

The second cylindrical portion 185 of the third connector constituent body 107a projects downward from a lower side of the first cylindrical portion 183 in the upper-lower direction. The first cylindrical portion 183 is located on an inner side of the second cylindrical portion 185 of the third connector constituent body 107a, with a cylindrical space interposed between the second cylindrical portion 185 and the first cylindrical portion 183. At this location, the third connector constituent body 107a is a double cylindrical form.

In the upper-lower direction, a lower end of the second cylindrical portion 185 of the third connector constituent body 107a is located lower than a lower end of the first cylindrical portion 183.

The body 163 closes an upper end of the first cylindrical portion 183 of the third connector constituent body 107a. The body 163 projects upward from the upper end of the first cylindrical portion 183 by a predetermined distance.

The mounting arm 165 is provided to project, toward one end side of the first radial direction, from a portion of the body 163 which projects upward from the upper end of the first cylindrical portion 183 by the predetermined distance. The terminal installing portion 167 is disposed on an upper side of the body 163. The third terminal 117 is provided in the terminal installing portion 167. The terminal installing portion 167 opens toward one end side of the second radial direction. A wire harness (not shown) installed to the terminal installing portion 167 (third terminal 117) extends toward one end side of the second radial direction.

As illustrated in FIGS. 16, 18, 23 and the like, the fourth connector constituent body 181 includes the first cylindrical portion 187 and the second cylindrical portion 189.

An outer diameter of the first cylindrical portion 187 of the fourth connector constituent body 181 is slightly smaller than an inner diameter of the first cylindrical portion 183 of the third connector constituent body 107a. A notch 201 is appropriately provided in an outer periphery of the first cylindrical portion 187 for reducing frictional coefficient when the fourth connector constituent body 181 moves with respect to the third connector constituent body 107a.

An outer diameter of the second cylindrical portion 189 of the fourth connector constituent body 181 is smaller than that of the second cylindrical portion 125a of the first connector constituent body 105a. A center axis C1 of the first cylindrical portion 187 of the fourth connector constituent body 181 and a center axis C1 of the second cylindrical portion 189 of the fourth connector constituent body 181 match with each other. The first cylindrical portion 187 is connected to an upper side of the second cylindrical portion 189.

The second elastic arm 193 projects downward from a lower end of the first cylindrical portion 187 of the fourth connector constituent body 181.

The step 195 is formed on an outer side of the second elastic arm 193 and at an intermediate portion of the fourth connector constituent body 181 in the upper-lower direction. A lower end of the first elastic arm 131a is located slightly lower than a lower end of the second cylindrical portion 125a of the first connector constituent body 105a.

Like the first elastic arms 131a, the plurality of (e.g., three) second elastic arms 193 are provided, the second elastic arms 193 are disposed such that they divide a circumference of the first cylindrical portion 187 into three.

In a state where the fourth connector constituent body 181 is located on an upper side of the first connector constituent body 105a and a center axis C1 of the fourth connector constituent body 181 and a center axis C1 of the first connector constituent body 105a match with each other and a lower end of the second cylindrical portion 189 of the fourth connector constituent body 181 and an upper end of the second cylindrical portion 125a of the first connector constituent body 105a are in contact with each other, the second elastic arms 193 respectively enter the notch 191 formed in the second cylindrical portion 125a of the first connector constituent body 105a, and the second elastic arms 193 do not turn around the center axis C1 with respect to the first connector constituent body 105a. Further, tip ends (lower ends) of the second elastic arms 193 respectively enter tip ends (upper ends) of the first elastic arms 131a, and the first elastic arm 131a and the second elastic arms 193 come into contact with each other.

A size from the step 195 to an upper end of the fourth connector constituent body 181 in the upper-lower direction is smaller than a size of the first cylindrical portion 183 of the third connector constituent body 107a in the upper-lower direction.

In a state where the fourth connector constituent body 181 is installed to the third connector constituent body 107a, a lower end of the first cylindrical portion 183 of the third connector constituent body 107a is in abutment against the step 195 of the fourth connector constituent body 181, the first cylindrical portion 187 of the fourth connector constituent body 181 enters the first cylindrical portion 183 of the third connector constituent body 107a, and a tip end of the second elastic arm 193 is located higher than a lower end of the second cylindrical portion 185 of the third connector constituent body 107a.

In a state where the fourth connector constituent body 181 is installed to the third connector constituent body 107a, the elastic body 142 exists on an inner side of the first cylindrical portion 183 of the third connector constituent body 107a and is interposed between the bottom wall 143a of the third connector constituent body 107a and the first cylindrical portion 187 of the fourth connector constituent body 181, and the elastic body 142 biases the fourth connector constituent body 181 downward.

Like the second embodiment, a recess 173 which opens upward is provided in the cylinder head 102 as illustrated in FIGS. 17A and 17B. If the connector 101a is attached to the cylinder head 102, a portion located above than the mounting arm 165 including the mounting arm 165 projects upward from the recess 173, and a portion located below the mounting arm 165 exists in the recess 173.

A bottom surface of the recess 173 of the cylinder head 102 is provided with a female screw (not shown) with which a male screw (not shown) of the second connector constituent body 103a is threadedly engaged.

The mounting arm 165 of the connector 101a installed to the cylinder head 102 is in contact with a portion of the cylinder head 102 in the vicinity of the recess 73. The mounting arm 165 (third connector constituent body 107a) is fixed to the cylinder head 102 through a fastening member such as a mounting screw (bolt) 175 and the like.

Next, assembling operation to install the first connector constituent body 105a, the third connector constituent body 107a and the fourth connector constituent body 181 on the second connector constituent body 103a which is attached to the cylinder head 102 will be described.

As an initial state, as illustrated in FIGS. 16, 17A, 18 and the like, the first connector constituent body 105a, the third connector constituent body 107a and the fourth connector constituent body 181 are integrally formed together. The integral bodies are separated from the second connector constituent body 103a and are located above the second connector constituent body 103a. In the initial state, the center axes C1 of the connector constituent bodies 103a, 1055a, 107a and 181 match with each other.

In the initial state, as illustrated in FIG. 18, a lower end of the first cylindrical portion 183 of the third connector constituent body 107a is in abutment against the step 195 of the second elastic arm 193. A tip end (lower end) of the second elastic arm 193 is in engagement with the first elastic arm 131a inside an upper end of the first elastic arm 131a. Further, a tip end (upper end) of the first elastic arm 131a enters a lower end of the second cylindrical portion 185 of the third connector constituent body 107a.

In the initial state, the third connector constituent body 107a is lowered. Then, the fourth connector constituent body 181 and the first connector constituent body 105a are also lowered, and the first connector constituent body 105a appropriately rotates around the center axis C1 with respect to the third connector constituent body 107a by the rotating and positioning mechanism. According to this, the first connector constituent body 105a comes to the regular rotating and fitting position with respect to the second connector constituent body 103a.

Subsequently, if the third connector constituent body 107a is further lowered, a lower portion of the first cylindrical portion 123a of the first connector constituent body 105a enters an upper end of the cylindrical portion 121a of the second connector constituent body 103a and starts fitting into the upper end of the cylindrical portion 121a as illustrated in FIG. 19.

If the third connector constituent body 107a is further lowered, as illustrated in FIG. 20, the above described fitting motion further proceeds, and the first elastic arm 131a is pushed by the second connector constituent body 103a and elastically deforms inward. A tip end of the first elastic arm 131a which was elastically deformed inward pushes a tip end of the second elastic arm 193 inward, and an outer size of the second elastic arm 193 becomes slightly smaller than an inner diameter of the first cylindrical portion 183 of the third connector constituent body 107a.

If the third connector constituent body 107a is further lowered, as illustrated in FIG. 21, the third connector constituent body 107a is further lowered with respect to the first connector constituent body 105a and the fourth connector constituent body 181, a lower end of the first cylindrical portion 183 of the third connector constituent body 107a abuts against a tip end (upper end) of the first elastic arm 131a, and the elastic body 142 is compressed.

Next, if the third connector constituent body 107a is further lowered, as illustrated in FIG. 22, the first elastic arm 131a restores, the locked pawl 133a of the first elastic arm 131a enters the through hole 129 of the second connector constituent body 103a, the locked portion 115a is locked with the locking portion 111a, and installing operation of the first connector constituent body 105a to the second connector constituent body 103a is completed.

The regular rotating and fitting position of the first connector constituent body 105a with respect to the second connector constituent body 103a by the rotating and positioning mechanism is completed before the second terminal 109 and the first terminal 113 start engaging with each other and before the locked pawl 133a of the first elastic arm 131a enters the through hole 129 (locking portion 111a).

Subsequently, if the third connector constituent body 107a is further lowered, as illustrated in FIG. 23, the locked portion-holding portion 119a which is a lower end of the first cylindrical portion 183 of the third connector constituent body 107a engages with a tip end of the restored first elastic arm 131a, and the locked portion-holding portion 119a is located inside the first elastic arm 131a. According to this, the locked portion-holding portion 119a engages with the locked portion 115a, and deforming motion of the first elastic arm 131a is stopped. Further, since the second cylindrical portion 185 of the third connector constituent body 107a is located outside the first elastic arm 131a and the second cylindrical portion 185 engages with the first elastic arm 131a, the first elastic arm 131a cannot deform outward either.

Subsequently, to adjust a direction of the third terminal 117, the third connector constituent body 107a is appropriately rotated and positioned with respect to the first connector constituent body 105a, and the third connector constituent body 107a is fixed to the cylinder head 102 using a bolt 175. According to this, the cylinder head 102, the first connector constituent body 105a, the second connector constituent body 103a and the third connector constituent body 107a are integrally connected to each other by a strong force.

According to the connector 101a, the first elastic arm 131a elastically deforms inward in a halfway state where the first connector constituent body 105a is installed to the second connector constituent body 103a. The first elastic arm 131a restores in a state where the installing operation of the first connector constituent body 105a on the second connector constituent body 103a is completed. Hence, it is possible to feel behavior of the first elastic arm 131a by a hand, and an operator can easily recognize a state where the installing operation of the first connector constituent body 105a on the second connector constituent body 103a is completed.

According to the connector 101a, the second connector constituent body 103a is biased by the elastic body 142 toward the first connector constituent body 105a and is connected. Hence, vibration resistance and electric contact properties are further enhanced.

What is claimed is:

1. A connector comprising:
a cylindrical first connector portion including a first housing portion on which a first terminal is placed;
a cylindrical second connector portion being fittable with the first connector portion and including a second housing portion on which a second terminal is disposed connectable to the first terminal; and
a cylindrical body portion which is rotatably provided on the first housing portion, wherein
the first housing portion and the second housing portion are fitted to each other, and in a fitting completion position where fitting operation between the first housing portion and the second housing portion is completed, the first terminal and the second terminal are connected to each other,
one of the first housing portion and the second housing portion is provided with an induction rib portion, and
the other one of the first housing portion and the second housing portion is provided with a rotating and positioning mechanism for guiding the induction rib portion such that the first housing portion and the second housing portion are located at a regular rotating and fitting position even if the induction rib portion is located at any of rotating positions up to a position before connection between the first terminal and the second terminal is started,
wherein the body portion includes an external connector portion on an opposite side of the first housing portion,
the connector further comprising:
an electric wire for connecting the first terminal and an external terminal of the external connector portion; and
a rotation-restricting portion for restricting excessive rotation of the first housing portion with respect to the body portion.

2. The connector according to claim 1, wherein
the rotating and positioning mechanism is an inclined surface in which cylindrical one end surface of the other one of the first housing portion and the second housing portion is the highest at a position opposed to the regular rotating and fitting position and is the lowest at the regular rotating and fitting position.

3. The connector according to claim 1, wherein
the first connector portion is provided with an locked portion,
the second connector portion is provided with an locking portion,
the body portion is provided with an locked portion-holding portion, and
when the first connector portion is installed on the second connector portion, the locked portion is locked with the locking portion, and the locked portion-holding portion holds a state where the locked portion is locked with the locking portion.

4. The connector according to claim 3, further comprising a biasing member for giving a force to maintain a fitted state between the first connector portion and the second connector portion when the first connector portion is installed on the second connector portion.
